(19) United States
(12) Patent Application Publication
(10) Pub. No.: US 2006/0066425 A1
(43) Pub. Date: Mar. 30, 2006

(54) Multi-phase electromagnetic relay assembly and motor assembly

(76) Inventor: Klaus A. Gruner, Village of Lakewood, IL (US)

Correspondence Address: MERONI + MERONI, P.O. BOX 309, BARRINGTON, IL, 60011, US

(21) Appl. No.: 11/237,428

(22) Filed: Sep. 28, 2005

Related U.S. Application Data
(60) Provisional application No. 60/614,218, filed on Sep. 29, 2004.

(51) Int. Cl. H01H 67/02

(52) U.S. Cl. 335/128

(57) ABSTRACT

An electromagnetic relay assembly enables multi-phase switching as achieved by a certain novel assemblies, including a motor assembly and a union transformer assembly, as cooperatively assembled within a housing assembly. The motor assembly comprises a union coil assembly cooperatively assembled with an actuator assembly. The union coil assembly comprises two tandemly-oriented unit coil assemblies as separated by certain stator-guiding structure. The actuator assembly comprises an actuator carriage, two sets of stator assemblies and a plurality of drive bridge assemblies. The stator-guiding structure guides the stator assemblies during actuation and the drive bridge assemblies cooperate with the union transformer assembly to selectively set and/or reset the relay assembly. The union transformer assembly comprises a plurality of unit transformer assemblies, each of which comprises a contact bridge assembly. The drive bridge assemblies are equal in number to the contact bridge assemblies and coact therewith to selectively set and/or rest the relay assembly.

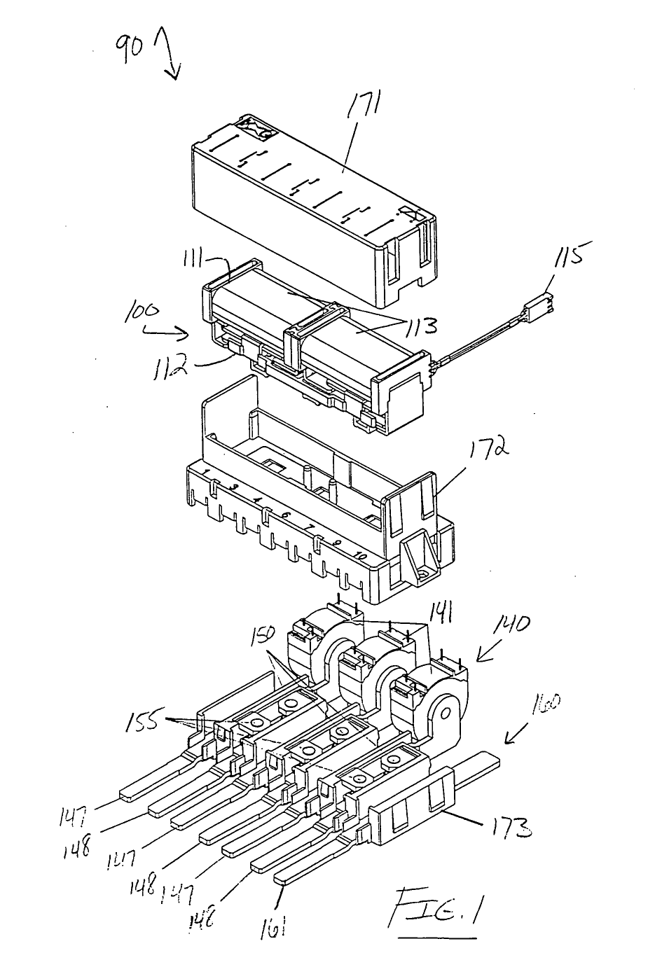

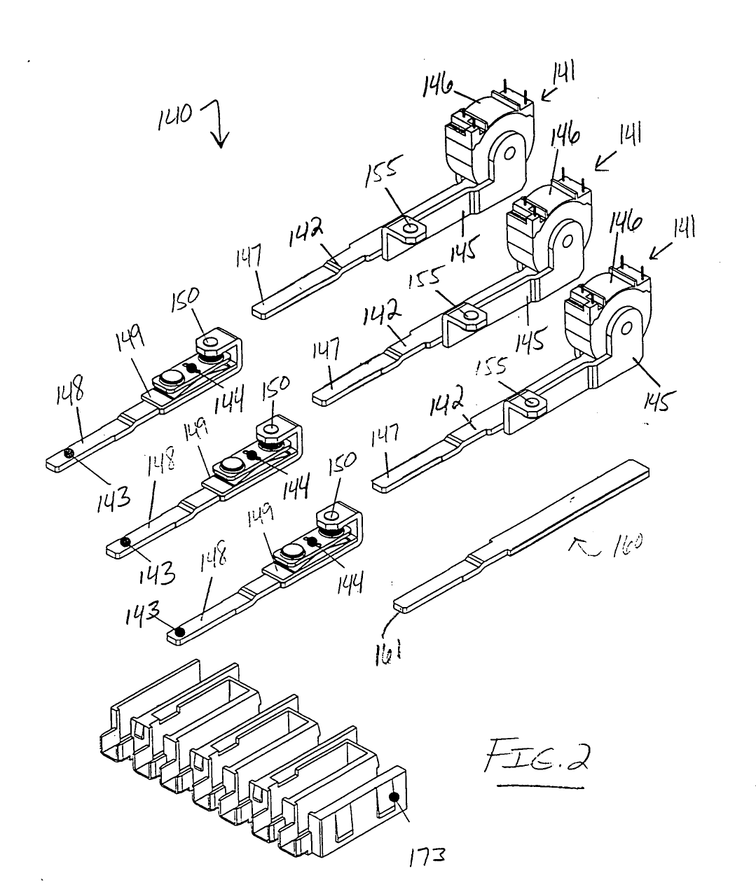

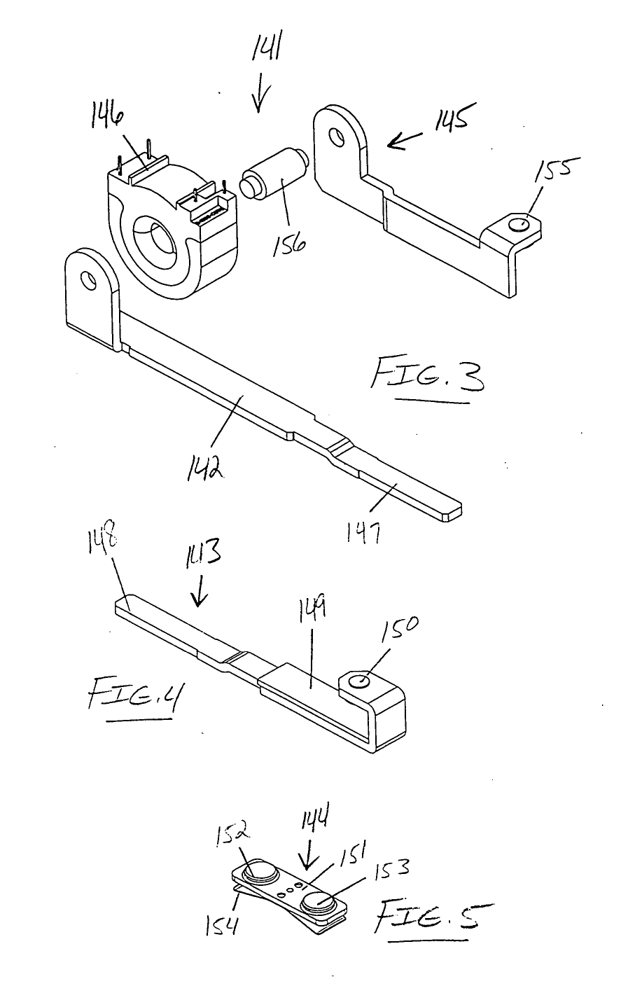

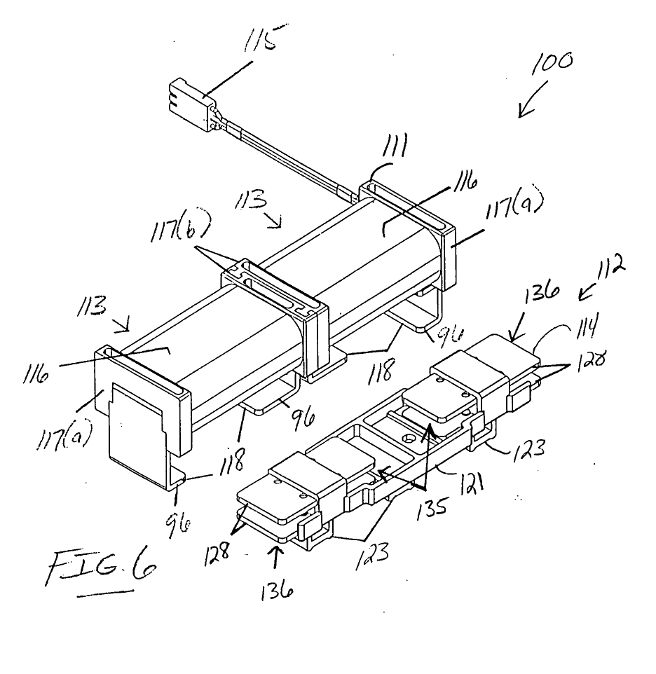

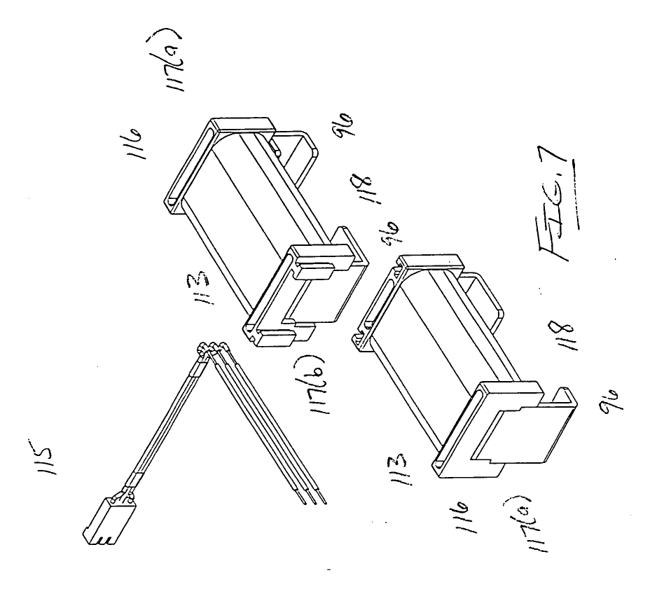

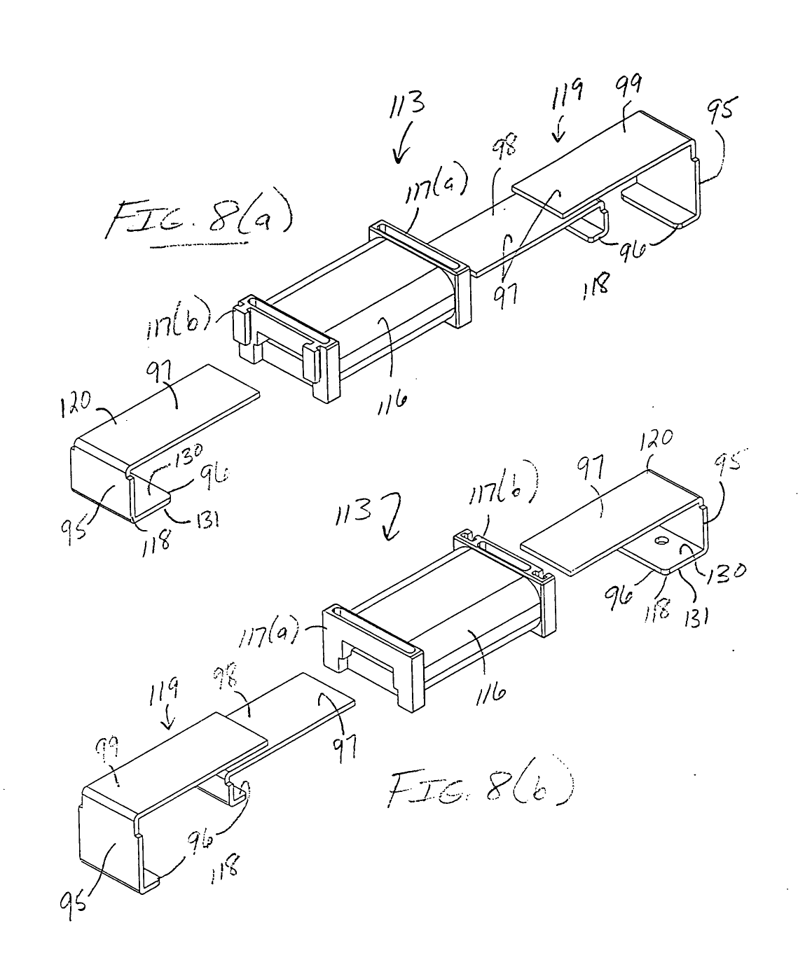

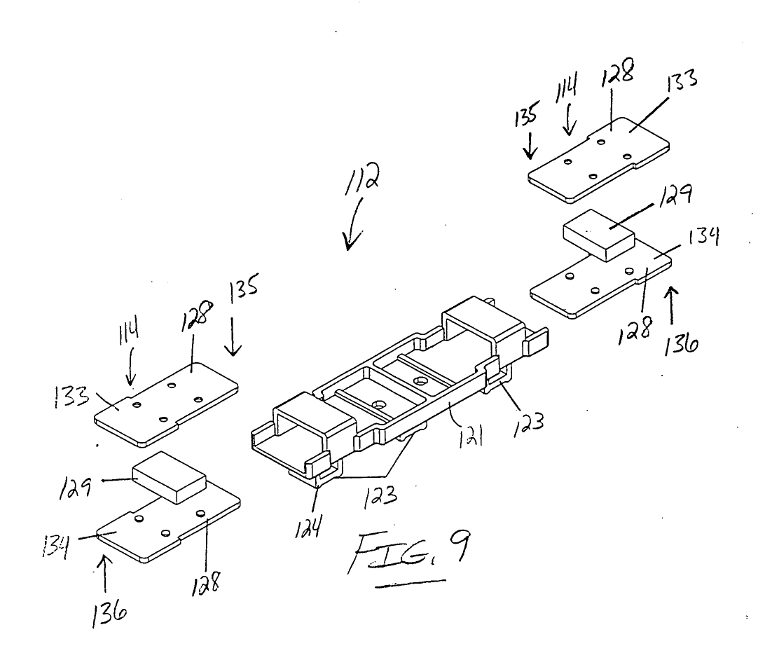

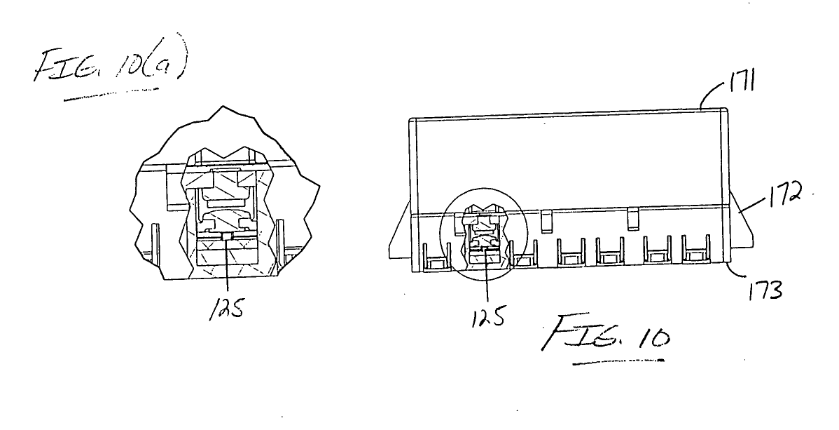

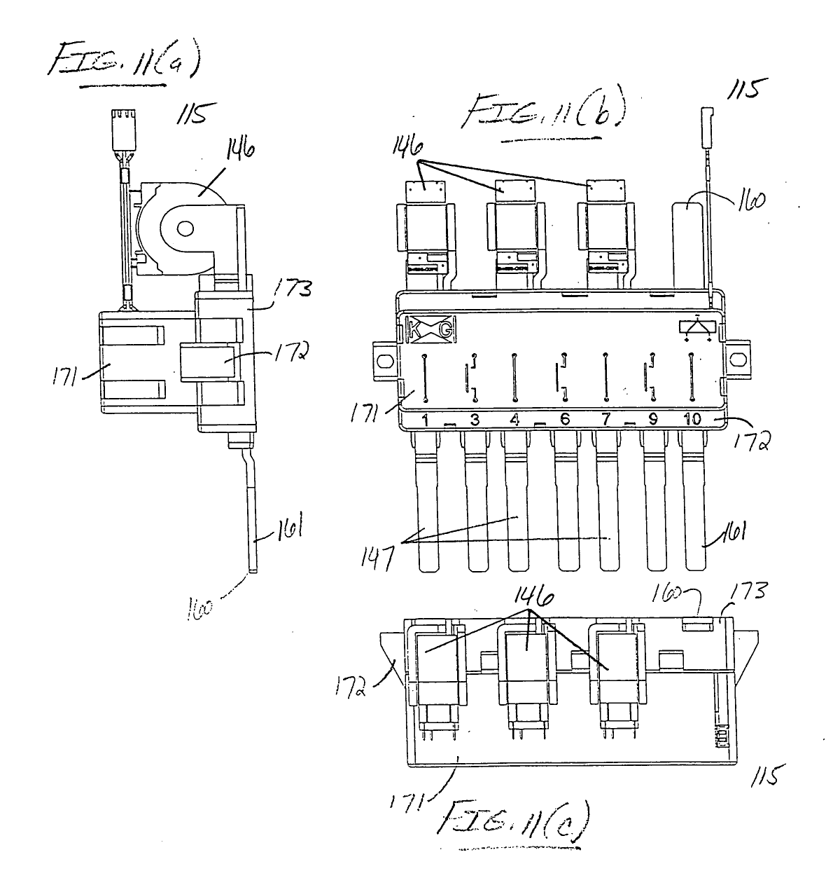

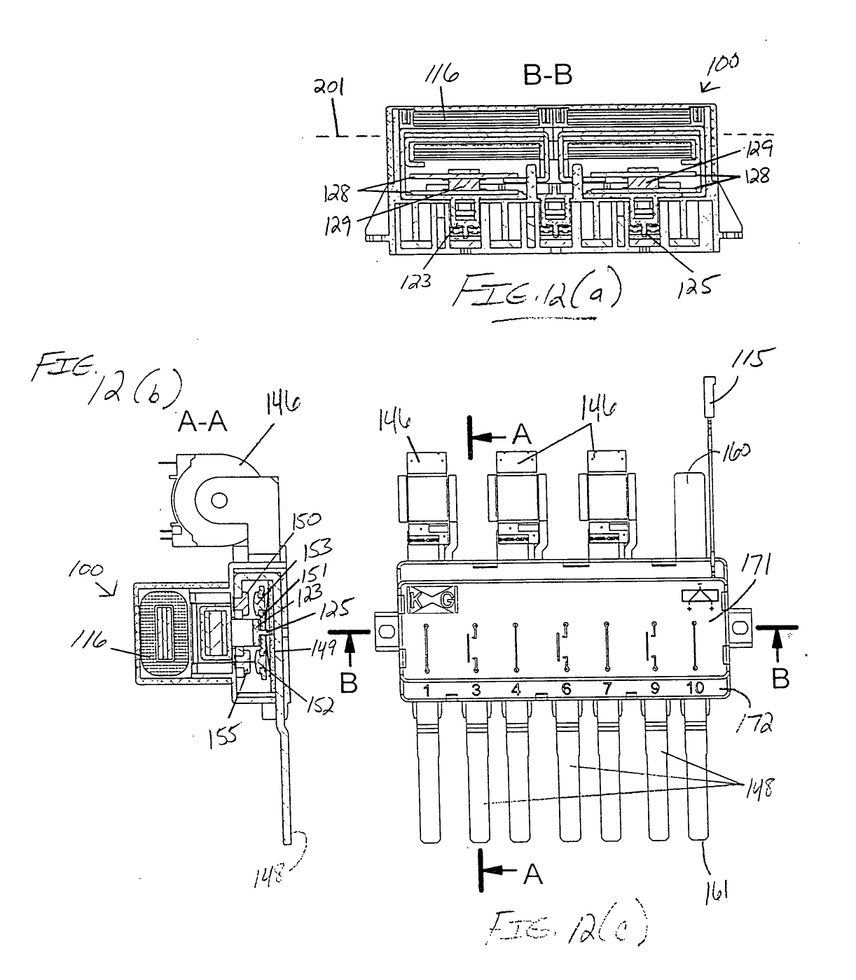

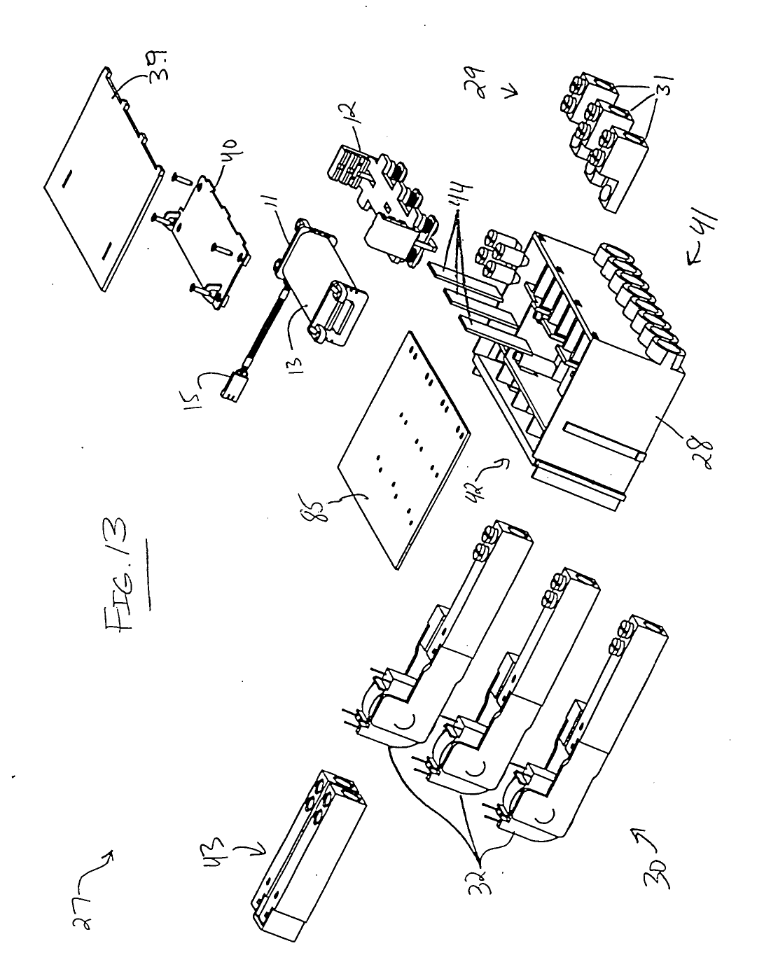

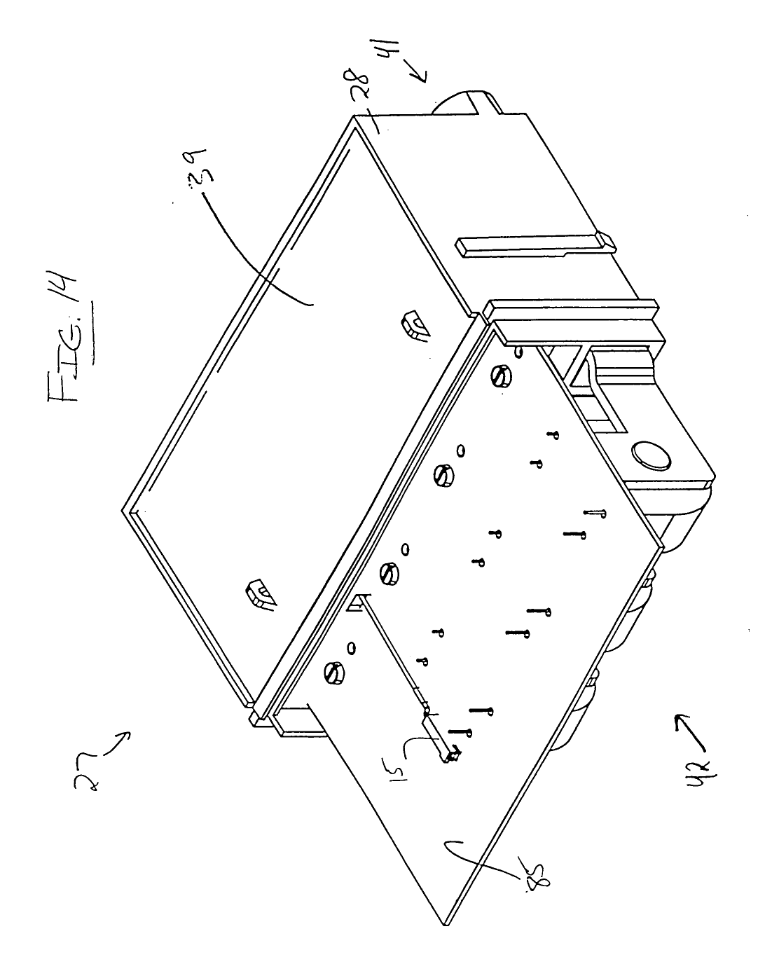

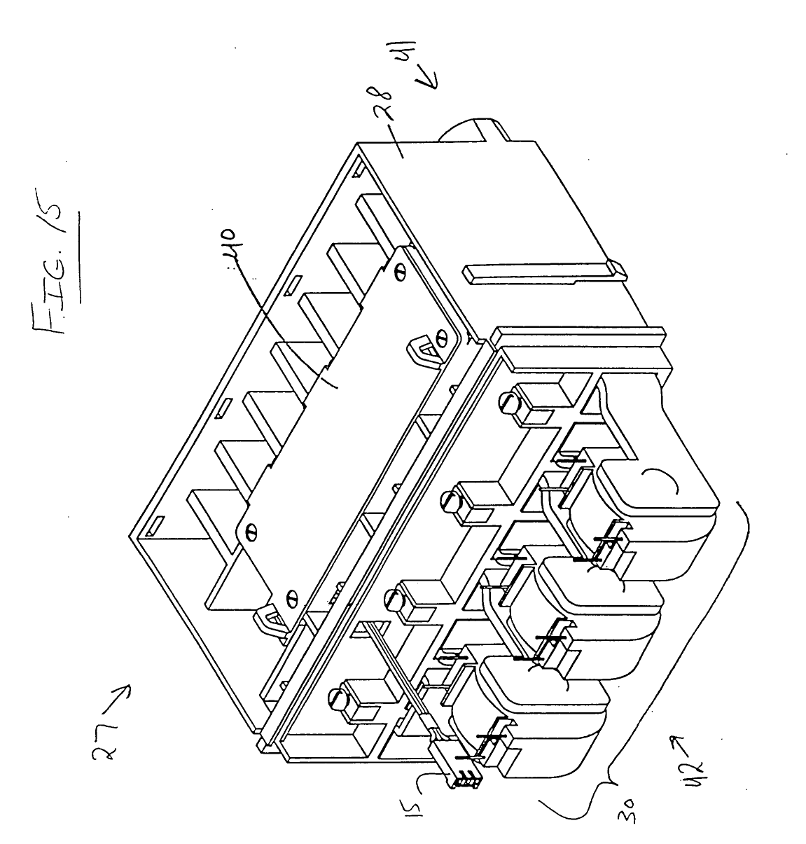

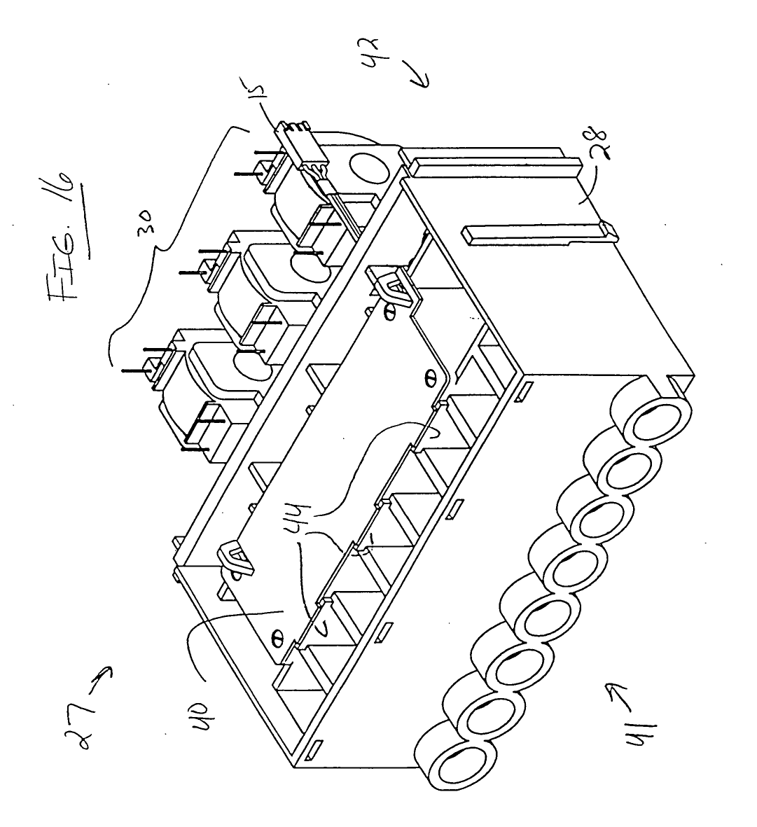

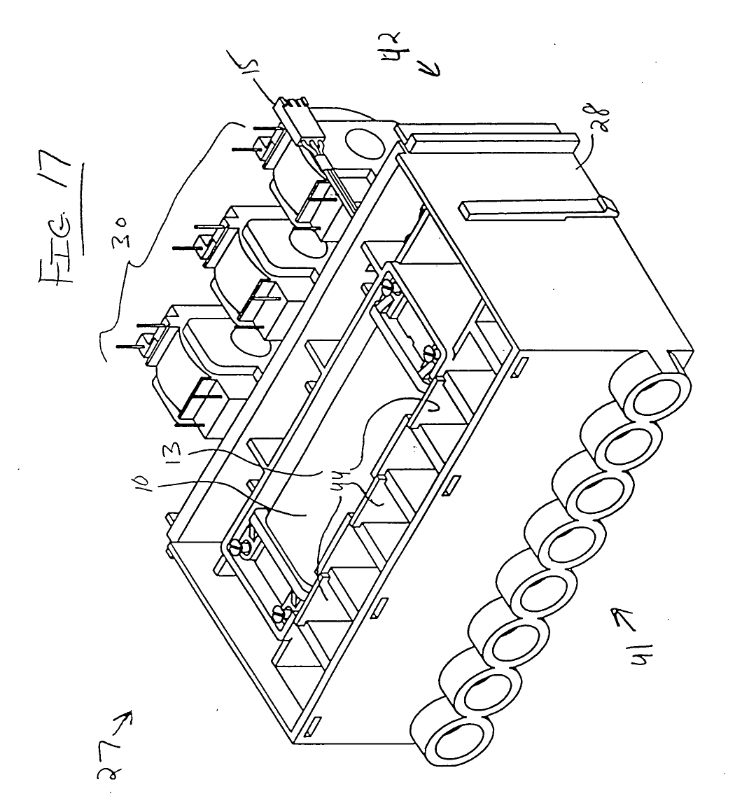

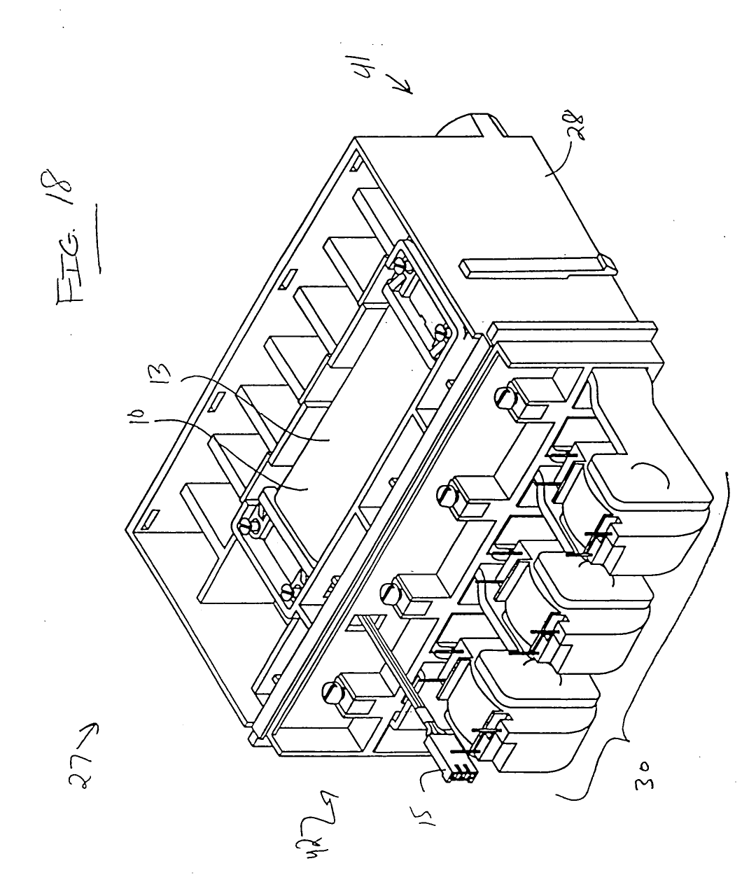

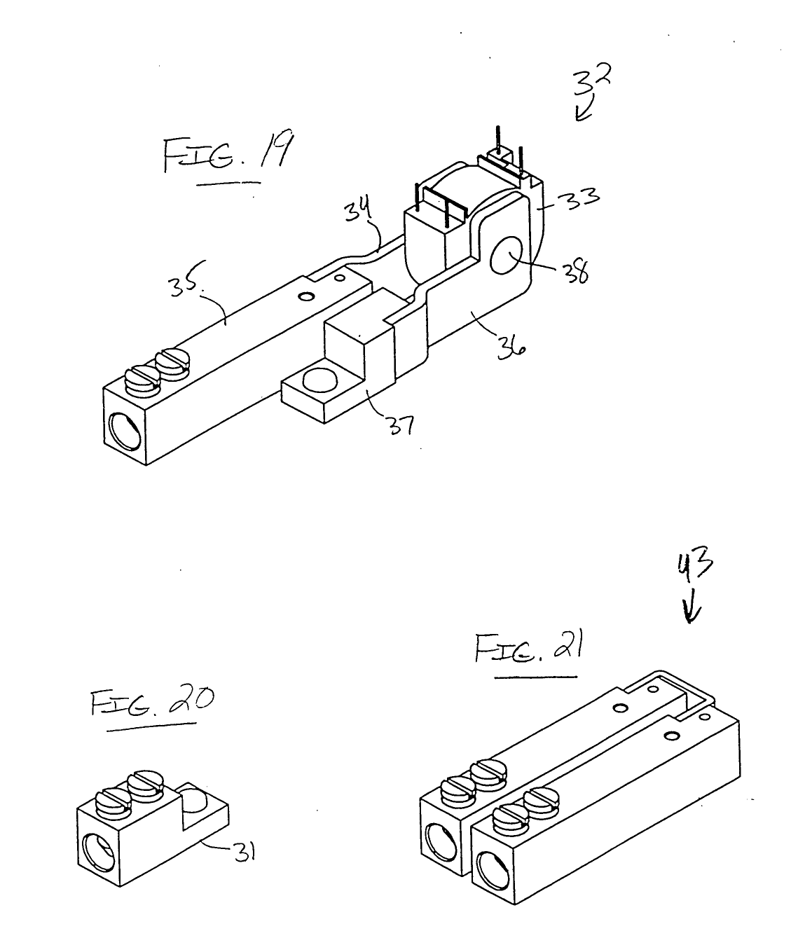

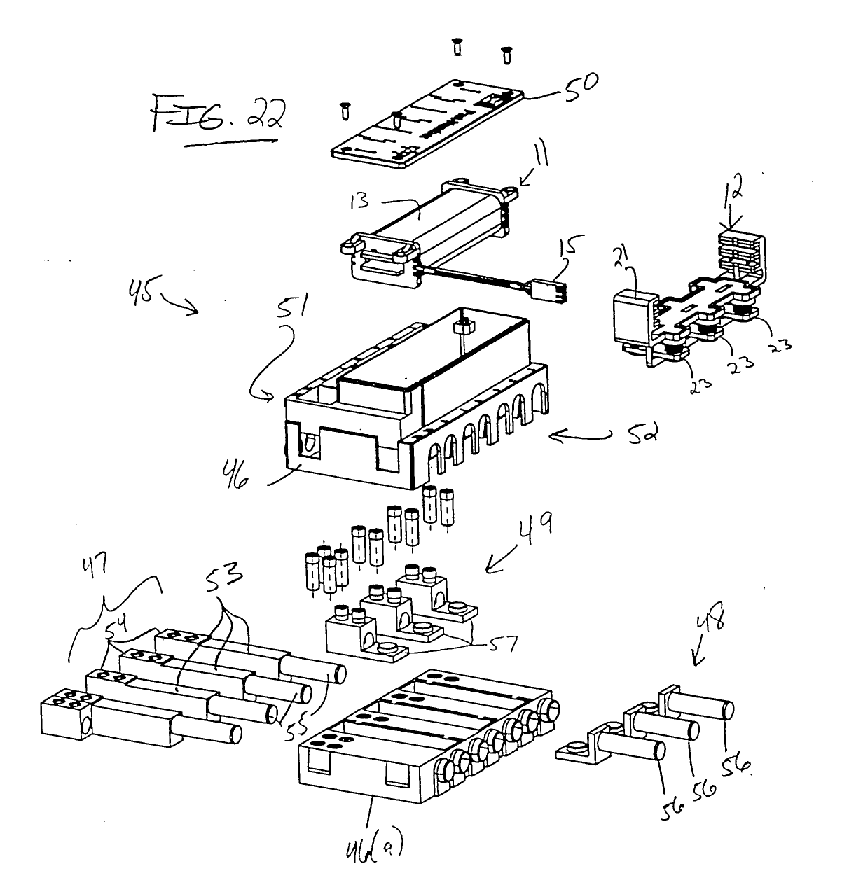

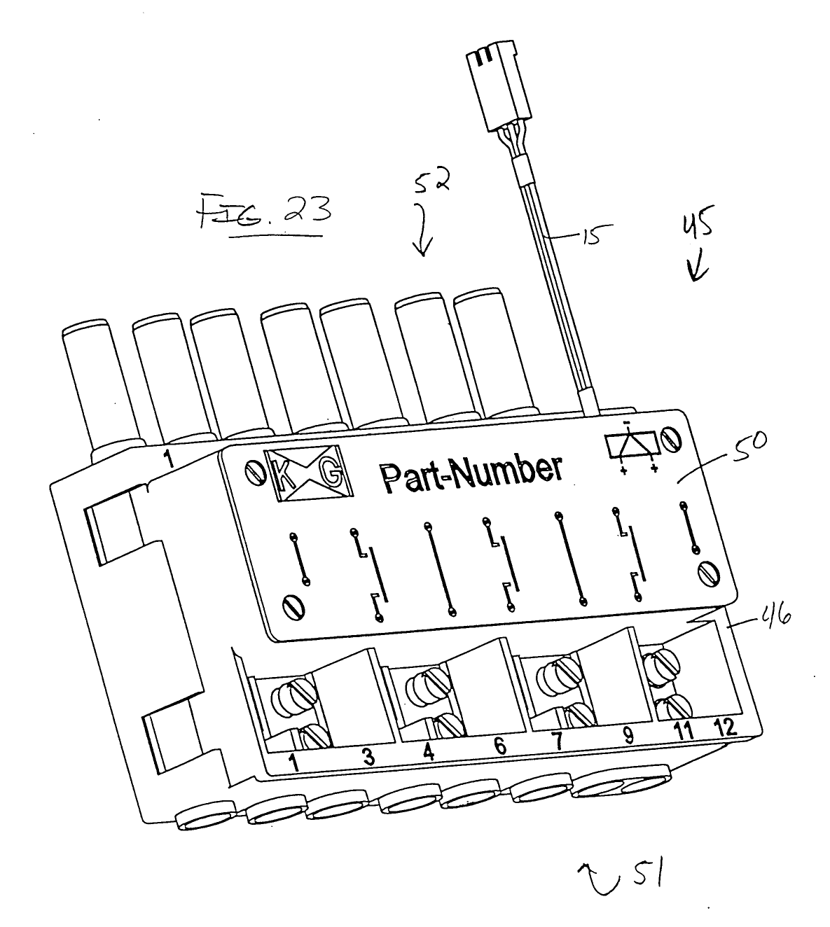

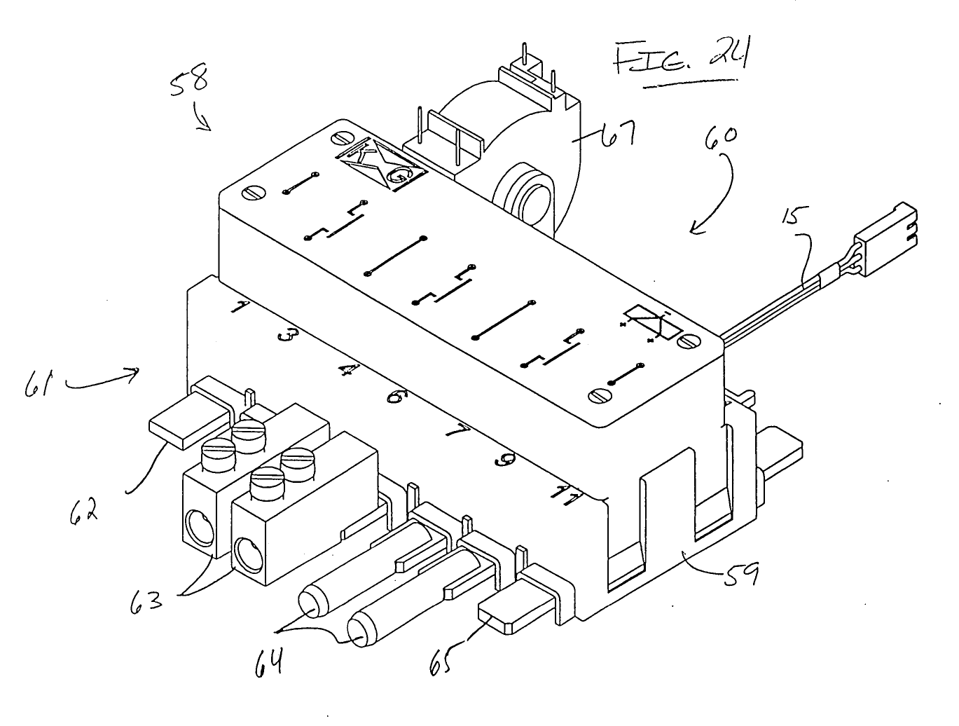

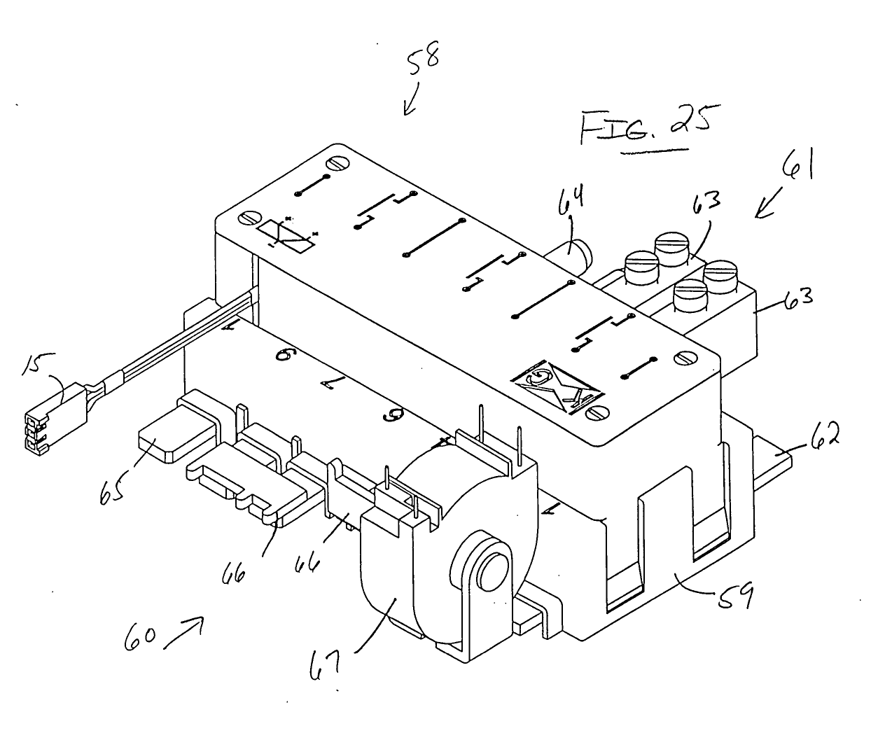

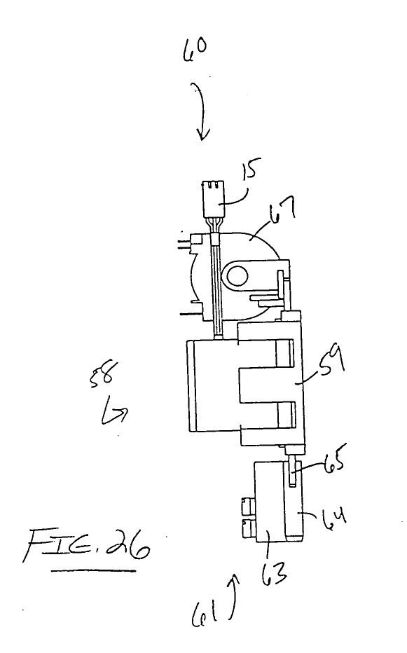

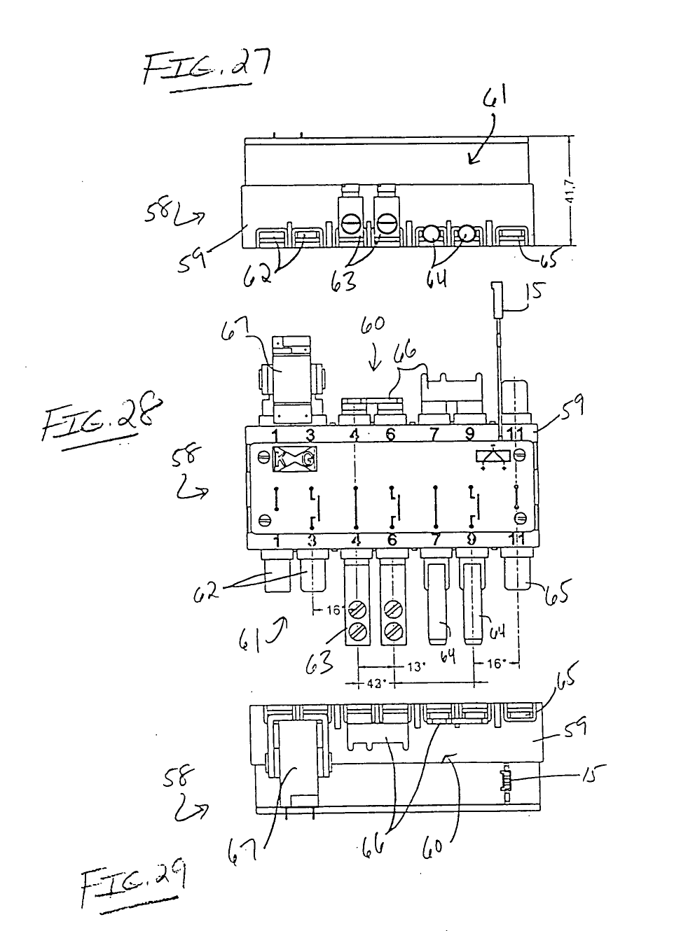

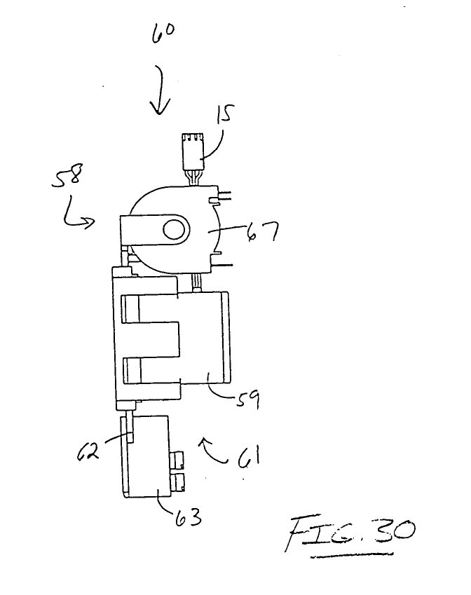

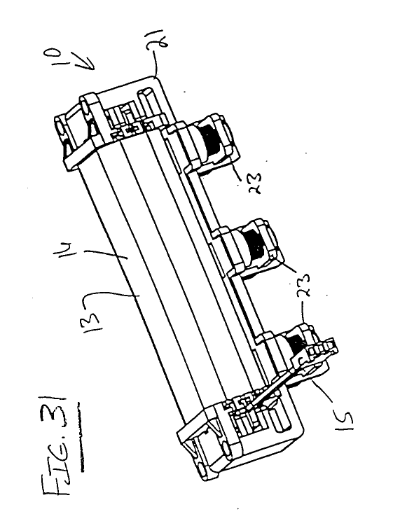

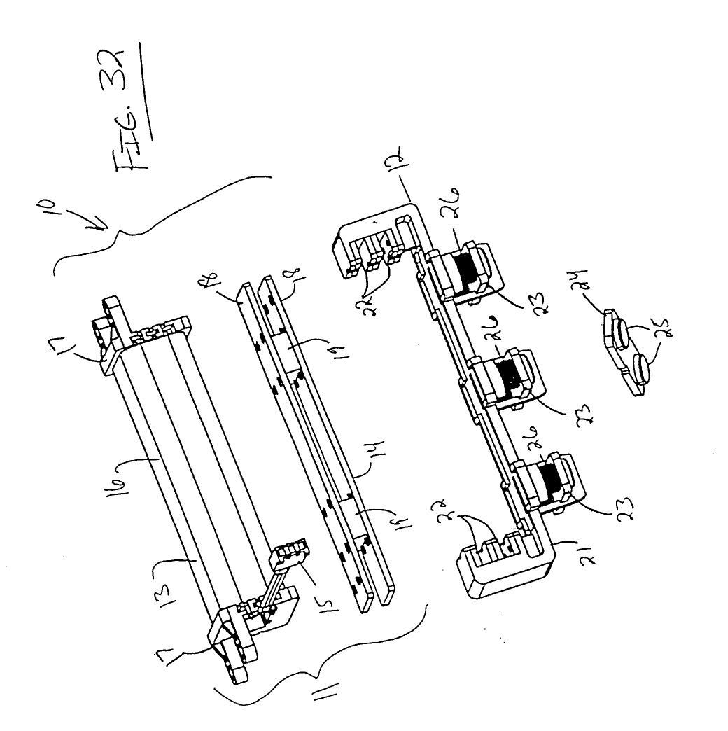

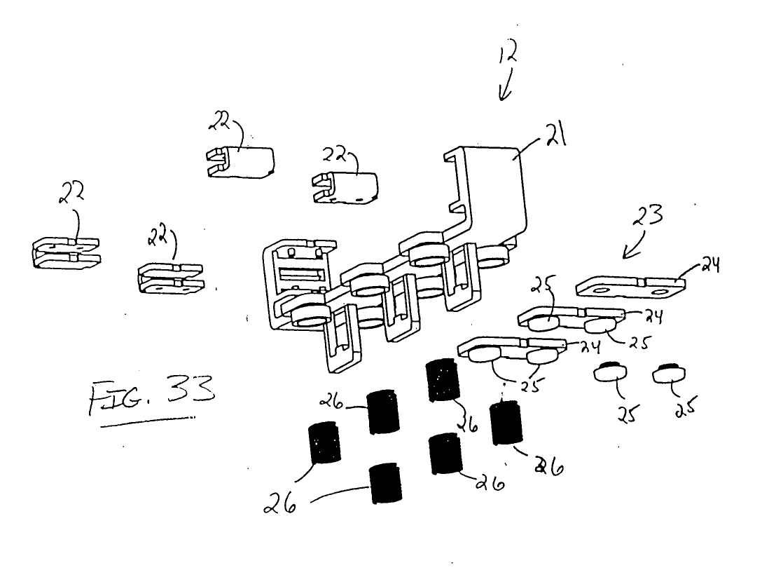

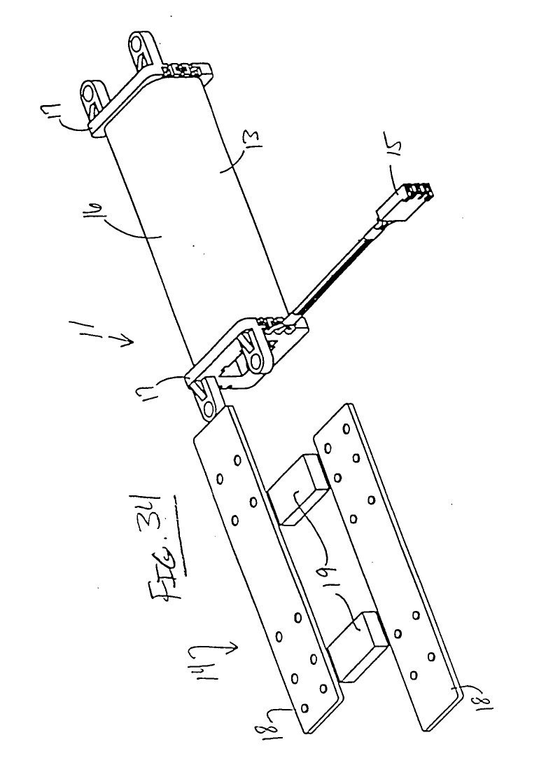

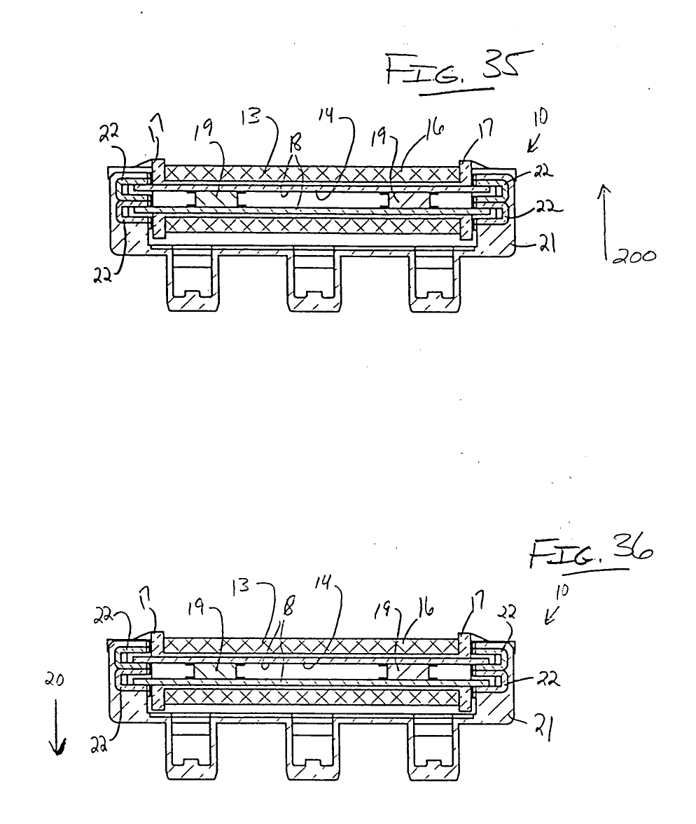

### PRIOR HISTORY

This application is a non-provisional patent application claiming the benefit of U.S. Provisional Patent Application No. 60/614,218, filed in the United States Patent and Trademark Office on Sep. 29, 2004.

### BACKGROUND OF THE INVENTION

### FIELD OF THE INVENTION

The disclosed invention generally relates to an electromagnetic relay assembly incorporating a uniquely configured motor assembly. More particularly, the disclosed invention relates to a multi-phase electromagnetic relay assembly for replacing a series of single pole relays and an electromagnetic motor assembly for driving the multi-phase electromagnetic relay assembly.

### BACKGROUND

Generally, the function of an electromagnetic relay is to use a small amount of power in the electro magnet to move an armature that is able to switch a much larger amount of power. By way of example, the relay designer may want the electro magnet to energize using 5 volts and 50 milliamps (250 milliwatts), while the armature can support 120 volts at 2 amps (240 watts). Relays are quite common in home appliances where there is an electronic control turning on (or off) some application device such as a motor or a light. The present teachings are primarily intended for use in kilowatt-hour or watt-hour consumption metering units typically designed with prepayment and/or remote connect/disconnect capability as the engineering goal. In other words, power companies delivering electric power to consumers are increasingly desirous of obtaining the capability to remotely turn on or turn off a consumer's power source. Power companies may achieve this remote connect/disconnect function by allowing or refusing a user's power source request at the consumption metering unit through the use of a remotely operated electromagnetic relay.

U.S. Pat. No. 5,694,099 ('099 Patent), which issued to Connell et al., discloses Switching Devices. The '099 Patent teaches, in particular, a switching device comprising a solenoid actuator and an inlet terminal attached to a first bus-bar. Mounted on the bus-bar is a flexible switch blade operable by the actuator and having a movable contact at its free end. An outlet terminal is connected by a second bus-bar to a fixed contact of the contact pair, the arrangement being such that in use an electrodynamic force is produced at least between the blade and the first bus-bar which tends to maintain the contacts in engagement

In is thus noted that prior art teaches metering units comprising a series of single pole relays that function in tandem with one another to selectively deliver power and thus, functionality, to various applications. The present invention discloses means to replace the series of single pole relays into a single unit comprising a uniquely configured motor assembly to drive the electromagnetic relay assembly. Thus, the effective multi-phase electromagnetic relay assembly may be summarized by the following descriptions.

### SUMMARY OF THE INVENTION

It is an object of the present disclosure to teach or provide a multi-phase electromagnetic relay assembly, as taught by a number of embodiments, namely, a preferred electromagnetic relay assembly, and at least three alternative electromagnetic relay assemblies. Each of the relay assemblies, however, may be outfitted with a uniquely configured motor assembly for driving the relay assembly. In this regard, it is contemplated that the present invention further teaches a uniquely configured electromagnetic motor assembly for driving any number of select multi-phase relay configurations.

The preferred electromagnetic relay assembly comprises a motor assembly, a transformer assembly, and a housing assembly. The motor assembly comprises at least one coil assembly and an actuator assembly. The coil assembly comprises a coil, opposing end bobbins, stator-guiding means, and a coil harness assembly. The actuator assembly comprises an actuator carriage, at least one stator assembly, and at least one drive bridge assembly. The end bobbins are cooperatively associated with the coil for forming a linear coil axis, the actuator carriage comprises stator-receiving means and bridge-receiving means, and thus, the actuator carriage receives and spatially locates both the stator assembly and the drive bridge assembly.

The stator assembly comprises a first RESET plate, a second SET plate, at least one drive magnet, and opposite stator ends, the drive magnet being sandwiched intermediate the RESET and SET plates. The drive bridge assembly comprises a drive bridge and a bridge-guiding means. The actuator assembly is cooperatively assembled with the coil assembly in that the stator ends are cooperatively guided by the stator-guiding means.

The transformer assembly comprises an IN-contact assembly, an OUT-contact assembly, contact bridging means, and a current transformer. The IN-contact assembly comprises an IN-terminal, and the OUT-assembly comprises an OUT-terminal and a first contact point. The contact bridging means comprise second, third, and fourth contact points, and certain contact-restoring means.

The housing assembly enables selective current-directing communication intermediate the contact points and the motor assembly. The coil harness assembly is cooperatively associated with the coil assembly for selectively directing electrical current therethrough, which serves to drive the actuator assembly.

The actuator assembly is cooperatively engageable with the transformer assembly for selectively setting the electromagnetic relay assembly. The SET plate interfaces with the stator-guiding means and the bridge-guiding means guide the drive bridges into spring-compressing contact with the contact bridge assembly thus separating the second and third contact points from the first and fourth contact points when the relay assembly is operatively set. Conversely, the RESET plate interfaces with the stator-guiding means and the bridge-guiding means guide the drive bridges into spring-restoring contact with the contact bridge assembly thus placing the second and third contact points into contact with the first and fourth contact points when the relay assembly is operatively reset.

The present invention further discloses a number of select configurations, including an inside-mounted type multi-phase electromagnetic relay assembly, a terminal-block type multi-phase electromagnetic relay assembly, and a plug-in type multi-phase electromagnetic relay assembly. Each of the several embodiments is driven by a uniquely configured motor assembly enclosed within a housing, which housing is typified by the given needs of the user. In this last regard, an alternative motor assembly may be outfitted with any of the select configurations.

The alternative motor assembly essentially comprises a coil-stator assembly and a movable contact assembly. The coil-stator assembly essentially comprises a coil assembly, a stator assembly, and a coil harness assembly. The coil assembly essentially comprises a coil and end-mounted bobbin(s). The stator assembly essentially comprises a pair of substantially parallel elongate stator plates, the stator plates being separated by two laterally spaced drive magnets, the flux of each drive magnet being generally directed orthogonally through the planes of the stator plates. The actuator assembly comprises an elongate actuator body, two sets of vertically spaced drive frames, and a plurality of contact bridge assemblies. The two sets of vertically spaced drive frames each set being spaced from one another at opposite ends of the actuator body. The contact bridge assemblies are spaced along the actuator body intermediate the drive frame sets. Each contact bridge assembly comprises a contact bridge, two contact rivets, and two contact pressure springs. Each of the embodiments may also incorporate the summarized alternative motor assembly, which alternative motor assembly is enclosed in a uniquely configured housing as per the user's specifications.

The motor assembly, whether preferred or alternative, as summarized, comprises a series of contact bridge assemblies. The number of contact bridge assemblies coincides with the number of sets of switches in the given application. Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief description of my patent drawings, as follows:

FIG. No. 1 is an exploded perspective view of the preferred embodiment of the electromagnetic relay assembly, showing a preferred motor assembly and union transformer assembly, and certain sections of a housing assembly.

FIG. No. 2 is an exploded perspective view of the union transformer assembly and a base section of the housing assembly, showing a plurality of unit transformer assemblies.

FIG. No. 3 is an exploded perspective view of an IN-contact assembly, a current transformer, and a contact member assembly, all sub-assemblies of a unit transformer assembly.

FIG. No. 4 is a perspective view of an OUT-contact assembly, a sub-assembly of a unit transformer assembly.

FIG. No. 5 is a perspective view of a contact bridge assembly, a sub-assembly of a unit transformer assembly.

FIG. No. 6 is an exploded perspective view of the preferred motor assembly, showing a union coil assembly and an actuator assembly.

FIG. No. 7 is an exploded perspective view of the union coil assembly, showing end-to-end unit coil assemblies and a coil harness assembly.

FIG. No. 8(a) is a partially exploded perspective view of a first unit coil assembly, showing a series of C-shaped frames exploded from coil-mounted end bobbins.

FIG. No. 8(b) is a partially exploded perspective view of a second unit coil assembly, showing a series of C-shaped frames exploded from coil-mounted end bobbins.

FIG. No. 9 is an exploded perspective view of the actuator assembly, showing two stator assemblies and an actuator carriage.

FIG. No. 10 is a first side plan view of the preferred embodiment of the electromagnetic relay assembly in an assembled state with parts broken away to show certain otherwise hidden internal structures.

FIG. No. 10(a) is a fragmentary enlarged view of the otherwise hidden internal structures depicted in FIG. No. 10.

FIG. No. 11(a) is a first end plan view of the preferred embodiment of the electromagnetic relay assembly in an assembled state.

FIG. No. 11(b) is a first top plan view of the preferred embodiment of the electromagnetic relay assembly in an assembled state.

FIG. No. 11(c) is second side plan view of the preferred embodiment of the electromagnetic relay assembly in an assembled state.

FIG. No. 12(a) is a cross-sectional side view of the preferred embodiment of the electromagnetic relay assembly in an assembled state as taken from FIG. No. 12(c).

FIG. No. 12(b) is a cross-sectional end view of the preferred embodiment of the electromagnetic relay assembly in an assembled state as taken from FIG. No. 12 (c).

FIG. No. 12(c) is a second top plan view of the preferred embodiment of the electromagnetic relay assembly, indicating certain cross-sectional views.

FIG. No. 13 is an exploded view of an alternative terminal-block-type, multi-phase electromagnetic relay assembly.

FIG. No. 14 is a perspective view of the alternative terminal-block-type, multi-phase electromagnetic relay assembly showing a PC board and a finger guard installed.

FIG. No. 15 is a first perspective view of the alternative terminal-block-type, multi-phase electromagnetic relay assembly in a partially disassembled state showing the PC board and the finger guard removed thus revealing the motor assembly cover plate as seen from a Terminal-OUT side.

FIG. No. 16 is a second perspective view of the alternative terminal-block-type, multi-phase electromagnetic relay assembly in a partially disassembled state showing the PC board and the finger guard removed thus revealing the motor assembly cover plate as seen from a Terminal-IN side.

FIG. No. 17 is the second perspective view of the alternative terminal-block-type, multi-phase electromagnetic relay assembly in a partially disassembled state showing the PC board, the finger guard, and the motor assembly cover plate removed thus revealing the motor assembly as seen from the Terminal-IN side.

FIG. No. 18 is the first perspective view of the alternative terminal-block-type, multi-phase electromagnetic relay assembly in a partially disassembled state showing the PC board, the finger guard, and the motor assembly cover plate removed thus revealing the motor assembly as seen from the Terminal-OUT side.

FIG. No. 19 is a perspective view of an alternative current transformer assembly.

FIG. No. 20 is a perspective view of an alternative “Switched Terminal-IN” assembly.

FIG. No. 21 is a perspective view of an alternative neutral terminal assembly.

FIG. No. 22 is an exploded perspective view of an alternative plug-in-type, multi-phase electromagnetic relay assembly.

FIG. No. 23 is a perspective view of the alternative plug-in-type, multi-phase electromagnetic relay assembly in an assembled state showing a motor assembly cover plate installed.

FIG. No. 24 is a first perspective view of an alternative inside-mounted-type, multi-phase electromagnetic relay assembly in an assembled state showing a cover plate installed as seen from a Terminal-IN side.

FIG. No. 25 is a second perspective view of the inside-mounted-type, multi-phase electromagnetic relay assembly in an assembled state showing a cover plate installed as seen from a Terminal-OUT side.

FIG. No. 26 is a first end plan view of the alternative inside-mounted-type, multi-phase electromagnetic relay assembly in an assembled state.

FIG. No. 27 is a Terminal-IN side plan view of the alternative inside-mounted-type, multi-phase electromagnetic relay assembly in an assembled state.

FIG. No. 28 is a top plan view of the alternative inside-mounted-type, multi-phase electromagnetic relay assembly in an assembled state.

FIG. No. 29 is a Terminal-OUT side plan view of the alternative inside-mounted-type, multi-phase electromagnetic relay assembly in an assembled state.

FIG. No. 30 is a second end plan view of the inside-mounted-type, multi-phase electromagnetic relay assembly in an assembled state.

FIG. No. 31 is a perspective view of an alternative motor assembly in an assembled state.

FIG. No. 32 is an exploded perspective view of the alternative motor assembly, showing an alternative coil assembly, an alternative stator assembly, and an alternative actuator assembly.

FIG. No. 33 is an exploded perspective view of the alternative actuator assembly.

FIG. No. 34 is an exploded perspective view of the alternative coil assembly and the alternative stator assembly.

FIG. No. 35 is a cross-sectional side view of the alternative motor assembly showing the alternative motor assembly in a RESET position.

FIG. No. 36 is a cross-sectional side view of the alternative motor assembly showing the alternative motor assembly in a SET position.

### DETAILED DESCRIPTION OF THE PREFERRED EMBODIMENT(S)

Referring now to the drawings, the preferred embodiment of the present invention concerns a multi-phase electromagnetic relay assembly 90 as generally illustrated and referenced in FIG. Nos. 1, 10, and 11(a) through 12(c). Electromagnetic relay assembly 90 preferably comprises a preferred motor assembly 100 as illustrated and referenced in FIG. Nos. 1, 6, 12(a), 12(b); a union transformer assembly 140 as illustrated and referenced in FIG. Nos. 1 and 2; and a housing assembly as generally depicted in FIG. No. 1. It will be seen from an inspection of FIG. No. 1 that the housing assembly essentially comprises a cover portion or cover 171, a component housing portion or component housing 172, and a base portion or base 173. Cover portion 171 is further referenced in FIG. Nos. 10, 11(a)-11(c), and 12(c); component housing portion 172 is further referenced in FIG. Nos. 10, 11(a)-11(c), and 12(c); and base portion 173 is further illustrated and referenced in FIG. Nos. 2, 10, and 11(a)-11(c). From a comparative consideration of FIG. Nos. 1 and 2, it will be understood that base portion 173 is preferably molded to receive custom current transformer assembly 140. Similarly, from a further comparative inspection of the applicable figures, it will be noted that component housing portion 172 is preferably molded to receive preferred motor assembly 100 and the custom current transformer assembly 140 (as base-received or received in base portion 173). Further, cover portion 171 is preferably molded to cover preferred motor assembly 100 (as housing-received or received in component housing portion 172).

Preferred motor assembly 100 comprises a parent or union coil assembly 111 as illustrated and referenced in FIG. Nos. 1 and 6; and an actuator assembly 112 as illustrated and reference in FIG. Nos. 1, 6, and 9. Union coil assembly 111 preferably comprises two unit coil assemblies 113 mounted in end-to-end relation such that the longitudinal axes thereof are substantially collinear as may be seen from a general inspection of FIG. Nos. 1, 6-8(b), and 12(a). It will be seen from an inspection of FIG. No. 12(a) that the collinear coil axis is referenced at 201. Each unit coil assembly 113 preferably comprises a coil 116 as illustrated and referenced in FIG. Nos. 1, 6-8(b), 12(a), and 129b); a distal end-mounted bobbin 117(a) as illustrated and referenced in FIG. Nos. 6-8(b); a proximal end-mounted bobbin 117(b) as illustrated and referenced in FIG. Nos. 6-8(b); a coil harness assembly 115 as illustrated and referenced in FIG. Nos. 1, 6, 7, 11(a)-11(c), and 12(c); and three vertically-spaced C-shaped metallic frames 118 as illustrated and referenced in FIG. Nos. 1, and 6-8(b).

It will thus be seen that preferred motor assembly 100 comprises two pairs of frame pairings, each pairing comprising three C-shaped frames 118. Each frame pairing (comprising three C-shaped frames) comprises a distal frame pairing 119 and a proximal frame 120 as specifically illustrated and referenced in FIG. Nos. 8(a) and 8(b). Each distal frame pairing 119 comprises a first or outer C-shaped frame 99 and a second or inner C-shaped frame 98. Each C-shaped frame 118 further comprises a top C portion 97 as illustrated and referenced in FIG. Nos. 8(a) and 8(b); a bottom C portion 96 as illustrated and referenced in FIG. Nos. 6-8(b); and a spine C portion 95 as further illustrated and referenced in FIG. Nos. 6-8(b). From a comparative inspection of FIG. Nos. 6 and 7 versus 8, it will be seen that inner C-shaped frame 98 is nestedly received in outer C-shaped frame 99 such that the top C portions 97 of inner and outer C-shaped frames 98 and 99 are in contact with one another and further such that the bottom C portions 96 of inner and outer C-shaped frames are vertically spaced from one another (the spine C portion 95 of outer C-shaped frame 99 having a length greater in magnitude than the length of the spine C portion of inner C-shaped frame 98). In other words, the bottom C portion 96 of inner C-shaped frame 98 is located in superior adjacency (as oriented in the illustrations) or in spaced adjacency to the bottom C portion 96 of outer C-shaped frame 99. It should be further noted that the bottom C portion 96 of each proximal C-shaped frame 120 comprises a superior frame surface 130 and an inferior frame surface 131 (as oriented in the illustrations) as generally referenced in FIG. Nos. 8(a) and 8(b).

Actuator assembly 112 preferably comprises an elongate actuator body 121 as illustrated and referenced in FIG. Nos. 6 and 9; two stator assemblies 114 as illustrated and referenced in FIG. Nos. 6 and 9; and a plurality of drive bridge assemblies 123 (preferably three) as illustrated and referenced in FIG. Nos. 6, 9, 12(a), and 12(b). Each stator assembly 114 preferably comprises a pair of substantially parallel stator plates 128 as illustrated and referenced in FIG. Nos. 6, 9, and 12(a). Each pair of stator plates 128 are preferably vertically separated (as oriented in the noted figures) by a drive magnet 129 and thus comprise a first or superior RESET plate 133 and a second or inferior SET plate 134 as illustrated and referenced in FIG. No. 9. Drive magnet 129 is further illustrated and referenced in FIG. No. 12(a). Further, each pair of stator plates 28 comprise a proximal stator end 135 and a distal stator end 136 as generally referenced in FIG. Nos. 6 and 9. The driving magnetic flux of each drive magnet 129 is preferably directed orthogonally through the planes in which the respective stator plates 128 lie.

It will be seen from an inspection of the noted figures that the C-shaped frame pairings 119 are spaced from one another at opposite ends of union coil assembly 111. Further, drive bridge assemblies 123 preferably number three and are spaced along actuator body 121 for assembled placement intermediate oppositely spaced C-shaped frame pairings 119. Each drive bridge assembly 123 preferably comprises a drive bridge 124 as illustrated and referenced in FIG. No. 9 and bridge-guiding means. The bridge-guiding means are preferably defined by a bridge guide member 125 as further illustrated and referenced in FIG. Nos. 12(a) and 12(b). Motor assembly 100, as described above, comprises a series of drive bridge assemblies 123. The preferred number of drive bridge assemblies 123 coincides with the number of sets of switches in the given application. In this last regard, it is preferred that the multi-phase electromagnetic relay comprise a three-phase electromagnetic relay and thus motor assembly 100 may preferably comprise three drive bridge assemblies 123 as generally illustrated and referenced in FIG. Nos. 6, 9, and 12(a).

It will be recalled from the section of this paper entitled: Brief Description of the Drawings that an alternative motor assembly 10 is generally illustrated in FIG. Nos. 35 and 36. FIG. No. 35 is essentially a cross-sectional side view of the alternative motor assembly 10 showing the alternative motor assembly 10 in a RESET position; and FIG. No. 36 is essentially a cross-sectional side view of alternative motor assembly 10 showing alternative motor assembly 10 in a SET position. It will be noted from an inspection of FIG. No. 36 that given a driving magnetic force 20 in which the net magnetic flux is directed downwards (orthogonally) relative to certain stator plates 18, the stator plates 18 of alternative motor assembly 10 are drawn into contact with the inferior most portion of certain drive frames or brackets 22. Thus, alternative motor assembly 10 is drawn into a SET position as generally depicted in FIG. No. 36. Certain contact springs 26 (compression coils), as illustrated in FIG. Nos. 15(b) and 17, become compressed during the setting process and thus tend toward equilibrium. Accordingly, during the resetting process, the expansive restorative forces 200 inherent in the contact springs 26 drive the stator plates 18 of alternative motor assembly 10 into contact with the superior most portion of the drive frames or brackets 22, thus drawing alternative motor assembly into a RESET position.

Similarly, with regard to preferred motor assembly 100, when preferred motor assembly 100 is drawn into a SET position (via a driving magnetic force 20 in which the driving magnetic flux is directed downwards (orthogonally) relative to stator plates 128), actuator assembly 112 moves in cooperative assemblage with union coil assembly 111 such that the distal stator ends 136 of inferior SET plates 134 contact the bottom C portions 96 of outer C-shaped frames 99, and the proximal stator ends 135 of superior RESET plates 133 contact the superior surfaces of the bottom C portions 96 of proximal C-shaped frames 120 as generally depicted in FIG. Nos. 12(a) and 12(b). When motor assembly 100 is drawn into a RESET position (via restorative forces inherent in certain contact springs 154 (as illustrated and referenced in FIG. No. 5), actuator assembly 112 moves in cooperative assemblage with union coil assembly 111 such that the distal stator ends 136 of superior RESET plates 133 contact the bottom C portions 96 of inner C-shaped frames 98, and the proximal stator ends 135 of inferior SET plates 134 contact the inferior surface of the bottom C portions 96 of proximal C-shaped frames 120 (as generally depicted in FIG. Nos. 10 and 10(a).

Union transformer assembly 140 preferably comprises a plurality of unit transformer assemblies 141 as illustrated and referenced in FIG. Nos. 1, 2, and FIG. Nos. 3-5, inclusive; and a neutral terminal assembly 160 as generally illustrated and referenced in FIG. Nos. 1, 2, 11(a)-11(c), and 12(c). The neutral terminal assembly 160 comprises a neutral terminal 161 as illustrated and referenced in FIG. Nos. 1, 2, 11(a), 11(b), and 12(c). Each unit transformer assembly 141 preferably comprises an IN-contact assembly 142 as illustrated and referenced in FIG. Nos. 2 and 3; an OUT-contact assembly 143 as illustrated and referenced in FIG. Nos. 2 and 4; a contact bridge assembly 144 as illustrated and referenced in FIG. Nos. 2 and 5; a contact member assembly 145 as illustrated and referenced in FIG. Nos. 2 and 3; and a current transformer 146 as illustrated and referenced in FIG. Nos. 2, 3, 11(a)-11(c), 12(b), and 12(c). Each IN-contact assembly 142 comprises an IN-terminal 147 as illustrated and referenced in FIG. Nos. 1-3, and 11(b). Each OUT-contact assembly comprises an OUT-terminal 148 as illustrated and referenced in FIG. Nos. 1, 2, 4, 12(b), and 12(c); an insulation plate 149 as illustrated and referenced in FIG. Nos. 1, 2, 4, and 12(b); and a first contact point 150 or rivet as illustrated and referenced in FIG. Nos. 1, 2, 4, and 12(b). Contact bridge assembly 144 comprises a contact bridge 151 as illustrated and referenced in FIG. Nos. 5 and 12(b); second and third contact points 152 and 153 (or rivets) as illustrated and referenced in FIG. Nos. 5 and 12(b); and contact spring 154 as illustrated and referenced in FIG. No. 5. Contact member assembly 145 comprises a fourth contact point 155 or rivet as illustrated and referenced in FIG. Nos. 1-3, and 12(b); and a core 156 as illustrated and referenced in FIG. No. 3.

More particularly, the preferred multi-phase, electromagnetic relay assembly of the present invention comprises motor assembly 100, union transformer assembly 140, and a housing assembly. It will be understood that motor assembly 100 is central to the invention and comprises in cooperative combination union coil assembly 111 and actuator assembly 112. The union coil assembly 111 preferably comprises two unit coil assemblies 113, each of which comprise a coil 116, a distal end bobbin 117(a), a proximal end bobbin 117(b), a C-frame arrangement, and a coil harness assembly 115. The proximal end bobbins 117(b) are cooperatively associated with one another for aligning the coils in end-to-end relation about a common coil axis 201. In this regard, it will be noted from a comparative inspection of FIG. Nos. 6 and 7 that proximal end bobbins 117(b) comprise tongue and groove type structure for becoming otherwise coupled to one another.

Each C-frame arrangement comprises a distal C-frame pairing 119 and a proximal C-shaped frame 120. The C-frame pairing 119 comprises an outer C-shaped frame 99 and an inner C-shaped frame 98. Each of the C-shaped frames comprises a top C portion 97, a bottom C portion 96, and a spine C portion 95. The top C portions 97 of the proximal C-shaped frames 120 are received by the proximal end bobbins 117(b) and the bottom C portions 96 of the proximal C-shaped frames 120 extend toward the distal end bobbins 117(a) in a common proximal bottom frame plane. Notably, the bottom C portions 96 of the proximal C-shaped frames 120 each comprise a first or superior frame surface 130 and a second or inferior frame surface 131.

The inner C-shaped frames 98 are nestedly received in the outer C-shaped frames 99 and the top C portions 97 of the inner and outer C-shaped frames 98 and 99 are received by the distal end bobbins 117(a). The bottom C portions 96 of the inner C-shaped frames 98 extend toward the proximal end bobbins 117(b) in a common inner bottom frame plane. Similarly, the bottom C portions 96 of the outer C-shaped frames 99 extend toward the proximal end bobbins 117(b) in a common outer bottom frame plane. The proximal bottom frame plane, the inner bottom frame plane, and the outer bottom frame plane are preferably substantially parallel to one another; the proximal bottom frame plane, however, extending intermediate the inner and outer bottom frame planes. Further, the top C portions 97 of the outer C-shaped frames 99 extend toward one another in a common outer top frame plane; the top C portions 97 of the inner C-shaped frames 98 extend toward one another in a common inner top frame plane; and the top C portions 97 of the proximal C-shaped frames 120 extend away from one anther in a common proximal top frame plane. Notably, the proximal top frame plane is sandwiched intermediate the outer top frame plane and the inner top frame plane in radially inward adjacency to the coils as may be seen from a general inspection of FIG. Nos. 12(a) and 12(b).

The actuator assembly 112 comprises an actuator carriage 121, a pair of stator assemblies 114, and a plurality of drive bridge assemblies 123. The actuator carriage 121 comprises certain stator-receiving means (in other words certain structure for receiving and retaining stator assemblies 114 in assemblage with actuator carriage 121) and certain bridge-receiving means (in other words, certain structure for receiving and/or retaining drive bridge assemblies 123 in assemblage with actuator carriage 121). Thus, the actuator carriage 121 functions to receive and spatially locate the stator assemblies 114 and the drive bridge assemblies 123, the main portions of the actuator carriage extending therebetween.

The stator assemblies 114 each comprise a first RESET plate 133, a second SET plate 134, a drive magnet 129, a proximal stator end 135, and a distal stator end 136. The drive magnet 129 is sandwiched intermediate the RESET and SET plates 133 and 134. Each drive bridge assembly 123 comprises a drive bridge 124 and a bridge guide member 125. The bridge guide members 125 extend orthogonally from the drive bridges 124 away from the actuator carriage 121. The stator assemblies 114 and the drive contact bridge assemblies 123, as received by the actuator carriage 121, are cooperatively assembled with the union coil assembly 111 as generally depicted in FIG. No. 1. In this regard, it will be recalled that the distal stator ends 136 are received intermediate the bottom C portions 96 of the inner and outer C-shaped frames 98 and 99, and the bottom C portions 96 of the proximal C-shaped frames 120 are received intermediate the RESET plates 133 and the SET plates 134 adjacent the proximal stator ends 135.

The union transformer assembly 140 essentially comprises a plurality of unit transformer assemblies 113. Each unit transformer assembly 113 comprises an IN-contact assembly 142, an OUT-contact assembly 143, a contact bridge assembly 144, a contact member assembly 145, and a current transformer 146. The IN-contact assembly comprises an IN-terminal 147 and the OUT-contact assembly comprises an OUT-terminal 148, an insulation plate 149, and a first contact rivet 150. The contact bridge assembly 144 comprises a contact bridge 151; second and third contact rivets 152 and 153, and a contact spring 154. The contact member assembly 145 comprises a fourth contact rivet and a core 155.

The housing assembly comprises a base section or base 173, a component housing section or housing 172, and a cover section or cover 171. Notably, the base 173 comprises transformer-receiving means (in other words, certain structure for receiving and retaining the union transformer assembly 140) and the component housing 172 comprises certain base-receiving means (in other words, certain structure for cooperatively receiving the base 173 (as perhaps outfitted with union transformer assembly 140) and certain motor-receiving means (in other words, certain structure for receiving motor assembly 100. The base 173 thus, receives the union transformer assembly 140; the base-receiving means thus receive the base-received union transformer assembly 140; and the motor-receiving means receive the motor assembly 100 (the motor assembly 100 being in communication with the union transformer assembly 140). The cover 171 covers the motor assembly 100 as received in the component housing 172.

The coil harness assembly 115 is cooperatively associated with the union coil assembly 111 for selectively directing electrical current therethrough. The selectively directed electrical current selectively drives the actuator assembly 112 and the actuator assembly 112 is cooperatively associated with the union transformer assembly 140 for selectively setting the multi-phase, electromagnetic relay assembly 90. During the setting process, the SET plates 134 interface with the bottom C portions 96 of the outer C-shaped frames 99 and the RESET plates 133 interface with the first frame surface 130 of the bottom C portions 96 of proximal C-shaped frames 120. The bridge guide members 125 guide the drive bridges 124 into spring-compressing contact with the contact bridge assemblies 144 thus separating the second and third contact rivets 152 and 153 from the first and fourth contact rivets 150 and 155 when the relay assembly 90 is selectively or operatively set. During the resetting process, the RESET plates 133 interface with the bottom C portions 96 of the inner C-shaped frames 98 and the SET plates 134 interface with the second frame surface 131 of the bottom C portions 96 of the proximal C-shaped frames 120. The bridge guide members 125 guide the drive bridges 124 through spring-restoring contact with the contact bridge assemblies 123 thus placing the second and third contact rivets 152 and 153 into contact with the first and fourth contact rivets 150 and 155 when the relay assembly 90 is selectively reset.

### Alternative Embodiment(s)

It is further contemplated that the present invention teaches certain alternative embodiments, namely, a terminal-block type multi-phase electromagnetic relay assembly 27 as generally illustrated and referenced in FIG. Nos. 13-18; a plug-in-type (or dock-on-type) multi-phase electromagnetic relay assembly 45 as illustrated and referenced in FIG. Nos. 22 and 23; and an inside-mounted-type, multi-phase electromagnetic relay assembly 58 as illustrated and referenced in FIG. Nos. 24-30. Each of the several embodiments may be driven by preferred motor assembly 100 or driven by a uniquely configured alternative motor assembly 10 as illustrated and referenced in FIG. Nos. 17-18, 31, 32, 35, and 36. In this regard, it s contemplated that motor assemblies 100 and 10 are both designed to be enclosed within a housing, which housing is typified by the given needs of the user and may thus take different forms for different applications.

Motor assembly 10 preferably comprises a coil-stator assembly 11 (the alternative coil assembly in combination with an alternative stator assembly) as illustrated and referenced in FIG. Nos. 13, 22, 32, and 34; and an alternative actuator assembly 12 as illustrated and reference in FIG. Nos. 13, 22, 32, and 33. Coil-stator assembly 12 preferably comprises an alternative coil assembly 13 as illustrated and referenced in FIG. Nos. 13, 18, 22, 31, 32, 34-36; and an alternative stator assembly 14 as illustrated and referenced in FIG. Nos. 32 and 34-36. The coil assembly 13 preferably comprises a coil 16 as illustrated and referenced in FIG. Nos. 31, 32, and 34-36; end-mounted bobbin(s) 17 as illustrated and referenced in FIG. Nos. 32 and 34-36; and an alternative coil harness assembly 15 as illustrated and referenced in FIG. Nos. 13-18, 22-26, 28-30, and 34. Stator assembly 14 preferably comprises a pair of substantially parallel elongate stator plates 18 as illustrated and referenced in FIG. Nos. 32 and 34-36. Stator plates 18 are preferably separated by two laterally-spaced drive magnets 19 as further illustrated and referenced in FIG. Nos. 32 and 34-36. The net magnetic force 20 directed through each drive magnet 19 is preferably directed orthogonally through the planes in which stator plates 18 generally lie as generally depicted in FIG. No. 35.

Actuator assembly 12 comprises an elongate actuator body 21 as illustrated and referenced in FIG. Nos. 22, 31, 32, 33, 35, and 36; two sets of vertically spaced drive frames 22 as illustrated and referenced in FIG. Nos. 32, 33, 35, and 36; and a plurality (preferably three) contact bridge assemblies 23 as illustrated and referenced in FIG. Nos. 22 and 31-33. It will be seen from an inspection of the noted figures that the two sets of vertically spaced drive frames 22 are spaced from one another at opposite ends of actuator body 21. Further, contact bridge assemblies 23 preferably number three and are spaced along actuator body 21 intermediate oppositely spaced drive frame 22. Each contact bridge assembly 23 preferably comprises a contact bridge 24 constructed from plain copper as illustrated and referenced in FIG. Nos. 32 and 33; two contact rivets 25 preferably constructed from AgCdO as illustrated and referenced in FIG. Nos. 32 and 33; and two contact pressure springs 26 preferably constructed from steel as illustrated and referenced in FIG. Nos. 32 and 33. As earlier stated, each of the alternative embodiments or contemplated embodiments of the multi-phase electromagnetic relay assembly may incorporate the motor assembly 10 which motor assembly 10 is enclosed in a uniquely configured housing having a Terminal-IN side and a Terminal-OUT side.

Motor assembly 10, as described above, comprises a series of contact bridge assemblies 23. The preferred number of contact bridge assemblies 23 coincides with the number of sets of switches in the given application. In this last regard, it is preferred that the multi-phase electromagnetic relay assembly comprise a three-phase electromagnetic relay assembly and thus motor assembly 10 comprises three contact bridge assemblies 23 as generally illustrated throughout the accompanying drawings.

Due to the nature and configuration of motor assembly 10, the present disclosure further teaches structure hereinafter referred to as “Through Un-switched” structure. The contact bridge assemblies 23 and the “Through Un-switched” structure together, in combination, bridge the gap between the Terminal-IN side and the Terminal-OUT side when motor assembly 10 is in a SET position as generally depicted in FIG. No. 36. Each of the alternative embodiments of the multi-phase electromagnetic relay assembly thus further incorporate the “Through Un-switched” structure as necessary cooperative structure associated with motor assembly 10. It will be further noted from an inspection of FIG. No. 36 that stator plates 18 are in contact with the inferior most portions of drive frames 22 when in a SET position. Alternatively, stator plates 18 are in contact with the superior most portions of drive frames 22 when motor assembly 10 is in a RESET position as generally depicted in FIG. No. 35 given certain restorative forces as inherent in contact springs 26.

The terminal-block-type, multi-phase electromagnetic relay assembly 27 is illustrated and referenced in FIG. Nos. 13-18. Terminal-block-type, multi-phase electromagnetic relay assembly 27 preferably comprises a custom terminal-block-type housing 28 for enclosing the earlier specified motor assembly 10 as illustrated and referenced in FIG. Nos. 13-18; a “Switched Terminal-IN” assembly 29 as illustrated and referenced in FIG. No. 13; and a custom current transformer assembly 30 as illustrated and referenced in FIG. Nos. 13 and 15-18.

It will be seen from an inspection of the noted figures that Switched Terminal-IN assembly 29 preferably comprises three Switched Terminal-IN's 31 as specifically illustrated and referenced in FIG. Nos. 13 and 20. It will be understood from an inspection of the noted figures that each Switched Terminal-IN 31 (preferably constructed from brass or copper) comprises two terminal screws and a contact rivet (preferably constructed from AgCdO). It will be further seen from an inspection of FIG. Nos. 13 and 19 that current transformer assembly 30 preferably comprises three Through Un-switched Terminal—Switched Terminal-OUT's 32. Each Through Un-switched Terminal—Switched Terminal-OUT 32 preferably comprises a current transformer 33, a frame 34 (preferably constructed from copper) that is brazed to a Through Un-switched terminal 35 (preferably constructed from brass or copper), a frame 36 (preferably constructed from copper) that is brazed to Switched Terminal-OUT 37, and a core 38 (preferably constructed from copper) riveted to frames 34 and 36 all as generally illustrated and referenced in FIG. No. 19. It will be further seen from an inspection of the noted figure that Through Un-switched terminal 35 preferably comprises at least one terminal screw and that Switched Terminal-OUT 37 preferably comprises a contact rivet constructed from AgCdO.

It will be seen that custom housing 28 preferably or generally comprises a custom finger guard 39 as illustrated and referenced in FIG. Nos. 13 and 14, and a custom cover plate 40 as illustrated and referenced in FIG. Nos. 13, 15, and 16 for enclosing motor assembly 10 within the body of custom housing 28. The custom housing body preferably or generally comprises a Terminal-IN side as generally referenced at 41 in FIG. Nos. 13-18 and a Terminal-OUT side as generally referenced at 42 in FIG. Nos. 13-18. It will be understood that motor assembly 10 is housed between Terminal-IN side 41 and Terminal-OUT side 42 for electromagnetically bridging the Switched Terminal-IN's 31 to the Through Un-switched Terminal—Switched Terminal-OUT's 32.

Further, a custom neutral terminals assembly 43 is also received in housing 28 and extends from Terminal-OUT side 42 to Terminal-IN side 41 adjacent the housed motor assembly 10. Neutral terminals assembly 43 is illustrated and referenced in FIG. Nos. 13 and 21. Neutral terminals assembly 43 preferably comprises two neutral terminals (preferably constructed from brass or copper) and a jumper frame (preferably constructed from copper). From an inspection of FIG. No. 21, it will be seen that the jumper frame is brazed to the neutral terminals.

As earlier specified, the Switched Terminal-IN assembly 29 typically comprises box terminals with set screws, which set screws are physically separated from motor assembly 10 by a series of custom divider plates 44 as illustrated and referenced in FIG. Nos. 13, 16, and 17. Notably, current transformer assembly 30 is typically cooperatively associated with a custom PC board 85 or other custom internal circuitry of the metering unit (not typically part of the relay assembly) as illustrated and referenced in FIG. Nos. 13 and 14. Custom PC board 85 thus cooperatively interacts with terminal-block-type, multi-phase electromagnetic relay assembly 27 according to the needs of the user.

The plug-in-type (or dock-on-type), multi-phase electromagnetic relay assembly 45 is generally illustrated and referenced in FIG. Nos. 22 and 23. Plug-in-type, multi-phase electromagnetic relay assembly 45 preferably comprises a plug-in-type housing 46 and a base 46(a) for enclosing the earlier specified motor assembly 10, which housing 46 is illustrated and referenced in FIG. Nos. 22 and 23 and which base 46(a) is illustrated and referenced in FIG. No. 22. Further, plug-in-type, multi-phase electromagnetic relay assembly 45 preferably comprises a Through Un-switched terminal assembly 47; a “Switched Terminal-OUT” assembly 48, and a “Switched Terminal-IN” assembly 49 all as illustrated and referenced in FIG. No. 22. The plug-in-type housing 46 preferably comprises a cover plate 50 for enclosing motor assembly 10 in the body of housing 46, which cover plate 50 is illustrated and referenced in FIG. Nos. 22 and 23. The body of housing 46 also preferably comprises a Terminal-In side as referenced at 51 in FIG. Nos. 22-23, and a Terminal-Out side as referenced at 52 in FIG. Nos. 22-23.

The Through Un-switched terminal assembly 47 comprises a series of Through Un-switched terminals 53, each of which are preferably received in Terminal-In side 51 and extend from Terminal-In side 51 to Terminal-Out side 52. It will be seen from an inspection of FIG. No. 22 that Through Un-switched terminals 53 have been illustrated and referenced. Thus, each Through Un-switched terminal 53 preferably comprises an IN side as referenced at 54 and an OUT side as referenced at 55 in FIG. No. 22. The IN sides 54 are juxtaposed adjacent Terminal-IN side 51 and the OUT sides 55 are juxtaposed adjacent the Terminal-OUT side 52. The Switched Terminal-OUT assembly 48 preferably comprises a series of Terminal-OUT terminals 56 as illustrated and referenced in FIG. No. 22, which Terminal-OUT terminals 56 are cooperatively associated with the OUT sides of the Through Un-switched terminals 53.

The Switched Terminal-IN assembly 49 preferably comprises a series of Terminal-IN terminals 57 as referenced in FIG. No. 22, which terminals 57 are cooperatively associated with the IN sides 54 of Through Un-switched terminals 53. The Terminal-OUT side 52 (or harness assembly side) is positioned for interfacing with the PC board or other internal circuitry of the metering unit. As earlier specified, harness assembly 15 is designed for operatively connecting coil assembly 13 to a PC board or other internal circuitry of a given application.

The inside-mounted-type, multi-phase electromagnetic relay assembly 58 preferably comprises motor assembly 10; a housing 59 as illustrated and referenced in FIG. Nos. 24-30; and various components as required by the user. Similar to the previously described embodiments, housing 59 comprises opposite sides, namely, a Terminal-OUT (or harness assembly) side as referenced at 60 in FIG. Nos. 24-26, and 28-30; and a Terminal-IN side as referenced at 61 in FIG. Nos. 24-28, and 30. As earlier described, Terminal-OUT side 60 is designed for positioned placement adjacent the PC board or other internal circuitry of the given metering unit and Terminal-IN side 61 is thus positioned external to the metering unit. It is noted that the Terminal-IN sides as described may comprise standard terminals as referenced at 62 in FIG. Nos. 24, 25, 27, 28, and 30; custom box terminals as referenced at 63 in FIG. Nos. 24-28, and 30; custom terminal pins as referenced at 64 in FIG. Nos. 24-28; and a neutral as referenced at 65 in FIG. Nos. 24-29. The Terminal-OUT sides as described may comprise optional shunt resistors (the maximum number of which is equal to the number of contact bridge assemblies) as referenced at 66 in FIG. Nos. 25, 28, and 29; optional current transformers (the maximum number of which is equal to the number of contact bridge assemblies) as referenced at 67 in FIG. Nos. 24-26 and 28-30; and a neutral terminal as previously referenced at 65.

It should be noted that the alternative embodiments of the present invention comprise certain select configurations, the select configurations being selected from the group consisting of a terminal-block type configuration, a dock-on type configuration, and an inside-mounted type configuration as taught by the foregoing specifications. In this regard, it is contemplated that state of the art modifications could be made to the select configurations by a person ordinarily skilled in the art to accommodate preferred motor assembly 100 as the preferred drive mechanism or motor for the select configuration.

Thus, while the foregoing descriptions detail a great deal of specificity, it is not intended that the invention necessarily be limited to specifications as set forth, but may be expanded in incorporate the key functions as provided by the essential form(s) of the inventive relay assembly. For example, it is contemplated that the present invention essentially discloses an electromagnetic relay assembly comprising a motor assembly, a transformer assembly, and a housing assembly, wherein the motor assembly comprises at least one coil assembly and an actuator assembly. The coil assembly comprises at least one coil, opposing end bobbins, stator-guiding means, and a coil harness assembly. The end bobbins are cooperatively associated with the coil for forming a linear coil axis. The actuator assembly comprises an actuator carriage, at least one stator assembly, and at least one drive bridge assembly. The actuator carriage comprises stator-receiving means and bridge-receiving means and thus, the actuator carriage receives and spatially locates the stator assembly and the drive bridge assembly. The stator assembly comprises a first RESET plate, a second SET plate, a drive magnet, and opposite stator ends. The drive magnet is sandwiched intermediate the RESET and SET plates. The drive bridge assembly comprises a drive bridge and certain bridge-guiding means. The actuator assembly is cooperatively assembled with the coil assembly in that the stator ends are cooperatively guided by the stator-guiding means.

The transformer assembly comprises an IN-contact assembly, an OUT-contact assembly, a contact bridge assembly, a contact member assembly, a current transformer, and optionally, a neutral terminal assembly. The IN-contact assembly comprises an IN-terminal and the OUT-assembly comprises an OUT-terminal, an insulation plate, and a first contact point. The contact bridge assembly comprises a contact bridge, second and third contact points, and a contact spring. The contact member assembly comprises a fourth contact point.

The housing assembly comprises a base section, a housing section, and a cover section. The housing section comprises certain basal section-receiving means and certain motor-receiving means. The base section, in like manner, comprises certain transformer-receiving means and thus, receives the transformer assembly. The housing section thus receives the motor assembly via the motor-receiving means and further receives the transformer assembly as base-received via the basal section-receiving means. The cover section covers the motor assembly as housing-received.

The coil harness assembly is cooperatively associated with the coil assembly for selectively directing electrical current therethrough for selectively driving the actuator assembly, the actuator assembly being cooperatively associated with the transformer assembly for selectively setting the electromagnetic relay assembly. The SET plate interfaces with the stator-guiding means and the bridge-guiding means guide the drive bridges into spring-compressing contact with the contact bridge assembly thus separating the second and third contact points from the first and fourth contact points when the relay assembly is operatively set. The RESET plate interfaces with the stator-guiding means and the bridge-guiding means guide the drive bridges into spring-restoring contact with the contact bridge assembly thus placing the second and third contact points into contact with the first and fourth contact points when the relay assembly is operatively reset.

The electromagnetic relay assembly, in a preferred form, may comprise certain multi-phasing means enabled by at least two tandemly-oriented coil assemblies, at least two stator assemblies, a plurality of drive bridge assemblies, and a plurality of transformer assemblies. The end-bobbins comprise cooperatively associated distal end bobbins and proximal end bobbins for aligning the coils in end-to-end relation about the (common) coil axis. Each stator assembly comprises a distal stator end and a proximal stator end. The distal stator ends of the SET plates interface with the stator-guiding means when the relay assembly is operatively set and the distal stator ends of the RESET plates interface with the stator-guiding means when the relay assembly is operatively reset.

The stator-guiding means may comprise a certain C-frame arrangement comprising certain C-frame pairing. The C-frame pairing essentially comprises two sets of oppositely-oriented, nested C-frames, namely, an outer C-shaped frame and an inner C-shaped frame. The inner C-shaped frames are nestedly received in the outer C-shaped frames. Each C-shaped frame comprises a top C portion, a bottom C portion, and a spine C portion (the C portions thus forming a C-shape). The top C portions of the inner and outer C-shaped frames are received by the distal end bobbins. The bottom C portions of the inner C-shaped frames extend toward the proximal end bobbins in a common inner bottom frame plane and the outer C-shaped frames extend toward the proximal end bobbins in a common outer bottom frame plane. The inner bottom frame plane and the outer bottom frame plane are substantially parallel and thus necessarily have a substantially uniform distance therebetween. The distal stator ends of the SET plates thus interface with the bottom C portions of the outer C-shaped frames when the relay assembly is operatively set and the distal stator ends of the RESET plates interface with the bottom C portions of the inner C-shaped frames when the relay assembly is operatively reset.

The stator-guiding means may further comprise a pair of proximal C-shaped frames, the bottom C portions of each proximal C-shaped frame comprising a first frame surface and a second frame surface. The top C portions of the proximal C-shaped frames are received by the proximal end bobbins. The bottom C portions of the proximal C-shaped frames extend toward the distal end bobbins in a common proximal bottom frame plane. The proximal bottom frame plane, the inner bottom frame plane, and the outer bottom frame plane are all substantially parallel; however, the proximal bottom frame plane extends intermediate the inner and outer bottom frame planes. The RESET plates further interface with the first frame surface of the proximal C-shaped frames when the relay assembly is operatively set and the SET plates interface with the second frame surface of C-shaped frames when the relay assembly is operatively reset.

Central to the invention is an electromagnetic motor assembly for use in combination with a relay assembly. The electromagnetic motor assembly comprises a union coil assembly and an actuator assembly. The union coil assembly preferably comprises two unit coil assemblies and a coil harness assembly. Each of the unit coil assemblies comprises a coil, a distal end bobbin, a proximal end bobbin, and stator-guiding means. The proximal end bobbins are cooperatively associated with one another for aligning the coils in end-to-end relation about a common coil axis The actuator assembly comprises an actuator carriage, a pair of stator assemblies, and a plurality of drive bridge assemblies. The stator ends of the stator assemblies are cooperatively guidable by the stator-guiding means. The coil harness assembly is cooperatively associated with the union coil assembly for selectively directing electrical current therethrough, which selectively directed electrical current selectively drives the actuator assembly. The actuator assembly may thus be co operable with an electromagnetic relay assembly for selectively setting the electromagnetic relay assembly.

When outfitted in combination with the relay assembly, the combination relay assembly comprises, in combination, the electromagnetic motor assembly, a plurality of transformer assemblies, and a housing assembly substantially as earlier specified. The combination relay assembly may comprise a select configuration as selected from the group consisting of a terminal-block type configuration, a dock-on type configuration, and an inside-mounted type configuration as further earlier specified. However, it is contemplated that the electromagnetic relay assembly must essentially comprise a motor assembly having at least one coil assembly and an actuator assembly, whereby the coil assembly comprising at least one coil, certain stator-guiding means (for example, end-bobbins 117(a) and/or (b) in combination with C-shaped frames 118), and certain coil-energizing means (such as coil harness assembly 115). The actuator assembly essentially comprising at least one stator assembly and certain force-transferring means (for example, drive bridge 124 or drive bridge assembly 123). The actuator assembly is cooperatively assembled with the coil assembly such that the stator assembly extends intermediate the stator-guiding means and comprises opposite stator ends, the stator ends being cooperatively guided by the stator-guiding means, the first and second stator plates of the stator assembly sandwich at least one drive magnet therebetween.

In cooperative communication with the motor assembly is at least one transformer assembly comprising an IN-contact assembly, an OUT-contact assembly, contact-bridging means (such as contact bridge assembly 144 in combination with contact member assembly 145), and a transformer. The IN-contact assembly comprises first current-directing-means (such as IN-terminal 147). The OUT-assembly comprises second current-directing-means (such as OUT-terminal 148) and a first contact point. The contact-bridging means comprising second, third, and fourth contact points, and certain contact-restoring means (such as contact spring 154).

Certain transformer-motor-interfacing means (such as the housing assembly) are further contemplated as proper for enabling selective current-directing communication intermediate the contact points. Thus, the coil-energizing means are cooperatively associated with the coil assembly for selectively directing electrical current therethrough, the electrical current for creating an actuating-force. The actuating-force, when present, actuates the actuator assembly and certain force-transferring means cooperatively engage the transformer assembly for directing current flow through the contact points. The current flow thus enabling electrical communication away from the relay assembly via the first and second current-directing means.

Thus, although the invention has been described by reference to a number of embodiments it is not intended that the novel device be limited thereby, but that modifications thereof are intended to be included as falling within the broad scope and spirit of the foregoing disclosure and the appended drawings.

I claim:

1. A multi-phase, electromagnetic relay assembly, the multi-phase electromagnetic relay assembly comprising in combination:
a motor assembly, the motor assembly comprising a union coil assembly and an actuator assembly, the union coil assembly comprising at least two unit coil assemblies and a coil harness assembly, the unit coil assemblies each comprising a coil, a distal end bobbin, a proximal end bobbin, and a C-frame arrangement, the proximal end bobbins being cooperatively associated for aligning the coils in end-to-end relation about a common coil axis, each C-frame arrangement comprising a distal C-frame pairing and a proximal C-shaped frame, each C-frame pairing comprising an outer C-shaped frame and an inner C-shaped frame, the C-shaped frames each comprising a top C portion, a bottom C portion, and a spine C portion, the top C portions of the proximal C-shaped frames being received by the proximal end bobbins, the bottom C portions of the proximal C-shaped frames extending toward the distal end bobbins in a common proximal bottom frame plane, the bottom C portions of the C-shaped frames comprising a first frame surface and a second frame surface, the inner C-shaped frame being nestedly received in the outer C-shaped frame, the top C portions of the inner and outer C-shaped frames being received by the distal end bobbins, the bottom C portions of the inner C-shaped frames extending toward the proximal end bobbins in a common inner bottom frame plane, the bottom C portions of the outer C-shaped frames extending toward the proximal end bobbins in a common outer bottom frame plane, the proximal bottom frame plane, the inner bottom frame plane, and the outer bottom frame plane being substantially parallel, the proximal bottom frame plane extending intermediate the inner and outer bottom frame planes, the actuator assembly comprising an actuator carriage, a pair of stator assemblies, and a plurality of drive bridge assemblies, the actuator carriage comprising stator-receiving means and bridge-receiving means, the actuator carriage receiving and spatially locating the stator assemblies and drive bridge assemblies, the stator assemblies each comprising a first RESET plate, a second SET plate, a drive magnet, a proximal stator end, and a distal stator end, the drive magnet being sandwiched intermediate the RESET and SET plates, the drive bridge assemblies each comprising a drive bridge and a bridge guide member, the bridge guide members extending orthogonally from the drive bridges away from the actuator carriage, the actuator assembly being cooperatively assembled with the union coil assembly, the distal stator ends being received intermediate the bottom C portions of the inner and outer C-shaped frames, the bottom C portions of the proximal C-shaped frames being received intermediate the RESET plate and the SET plate at the proximal stator ends;
a union transformer assembly, the union transformer assembly comprising a plurality of unit transformer assemblies, each unit transformer assembly comprising an IN-contact assembly, an OUT-contact assembly, a contact bridge assembly, a contact member assembly, and a current transformer, the IN-contact assembly comprising an IN-terminal, the OUT-assembly comprising an OUT-terminal, an insulation plate, and a first contact point, the contact bridge assembly comprising a contact bridge, second and third contact points, and a contact spring, the contact member assembly comprising a fourth contact spring; and
a housing assembly, the housing assembly comprising a base section, a housing section, and a cover section, the base section comprising transformer-receiving means, the housing section comprising base-receiving means and motor-receiving means, the base section receiving the union transformer assembly via the transformer-receiving means, the housing section receiving the motor assembly via the motor-receiving means and the base-received union transformer assembly via base-receiving means, the cover section covering the motor assembly as housing-received, the coil harness assembly being cooperatively associated with the union coil assembly for selectively directing electrical current therethrough, the electrical current for selectively driving the actuator assembly, the actuator assembly being cooperatively associated with the union transformer assembly for selectively setting the multi-phase, electromagnetic relay assembly, the SET plates interfacing with the bottom C portions of the outer C-shaped frames, the RESET plates interfacing with the first frame surface of the proximal C-shaped frames, and the bridge guide members guiding the drive bridges into spring-compressing contact with the contact bridge assemblies thus separating the second and third contact points from the first and fourth contact points when the relay assembly is selectively set, the RESET plates interfacing with the bottom C portions of the inner C-shaped frames, the SET plates interfacing with the second frame surface of the proximal C-shaped frames, and the bridge guide members guiding the drive bridges into spring-restoring contact with the contact bridge assemblies thus placing the second and third contact points into contact with the first and fourth contact points when the relay assembly is selectively reset.

2. The multi-phase electromagnetic relay assembly of claim 1 wherein the union transformer assembly comprises a neutral terminal assembly.

3. The multi-phase electromagnetic relay assembly of claim 1 comprising a select configuration, the select configuration being selected from the group consisting of a terminal-block type configuration, a dock-on type configuration, and an inside-mounted type configuration.

4. The multi-phase electromagnetic relay assembly of claim 1 wherein the top C portions of the outer C-shaped frames extend toward one another in a common outer top frame plane, the top C portions of the inner C-shaped frames extend toward one another in a common inner top frame plane, and the top C portions of the proximal C-shaped frames extend away from one anther in a common proximal top frame plane, the proximal top frame plane being sandwiched intermediate the outer top frame plane and the inner top frame plane in radially inward adjacency to the coils.

5. An electromagnetic relay assembly, the electromagnetic relay assembly comprising, in combination:
a motor assembly, the motor assembly comprising at least one coil assembly and an actuator assembly, the coil assembly comprising a coil, opposing end bobbins, stator-guiding means, and a coil harness assembly, the actuator assembly comprising an actuator carriage, at least one stator assembly, and at least one drive bridge assembly, the end bobbins being cooperatively associated with the coil for forming a linear coil axis, the actuator carriage comprising stator-receiving means and bridge-receiving means, the actuator carriage receiving and spatially locating the stator assembly and the drive bridge assembly, the stator assembly comprising a first RESET plate, a second SET plate, a drive magnet, and opposite stator ends, the drive magnet being sandwiched intermediate the RESET and SET plates, the drive bridge assembly comprising a drive bridge and a bridge-guiding means, the actuator assembly being cooperatively assembled with the coil assembly, the stator ends being cooperatively guided by the stator-guiding means;
at least one transformer assembly, the transformer assembly comprising an IN-contact assembly, an OUT-contact assembly, contact bridging means, and a current transformer, the IN-contact assembly comprising an IN-terminal, the OUT-assembly comprising an OUT-terminal, and a first contact point, the contact bridging means comprising second, third, and fourth contact points, and contact-restoring means; and
a housing assembly, the housing assembly for enabling selective current-directing communication intermediate the contact points and the motor assembly, the coil harness assembly being cooperatively associated with the coil assembly for selectively directing electrical current therethrough, the electrical current for selectively driving the actuator assembly, the actuator assembly being cooperatively engageable with the transformer assembly for selectively setting the electromagnetic relay assembly, the SET plate interfacing with the stator-guiding means and the bridge-guiding means guiding the drive bridges into spring-compressing contact with the contact bridge assembly thus separating the second and third contact points from the first and fourth contact points when the relay assembly is operatively set, the RESET plate interfacing with the stator-guiding means and the bridge-guiding means guiding the drive bridges into spring-restoring contact with the contact bridge assembly thus placing the second and third contact points into contact with the first and fourth contact points when the relay assembly is operatively reset.

6. The electromagnetic relay assembly of claim 5 comprising multi-phasing means, the multi-phasing means being enabled by at least two tandemly-oriented coil assemblies, at least two stator assemblies, a plurality of drive bridge assemblies, and a plurality of transformer assemblies, the end-bobbins comprising cooperatively associated distal end bobbins and proximal end bobbins for aligning the coils in end-to-end relation about the coil axis, each stator assembly comprising a distal stator end and a proximal stator end, the distal stator ends of the SET plates interfacing with the stator-guiding means when the relay assembly is operatively set and the distal stator ends of the RESET plates interfacing with the stator-guiding means when the relay assembly is operatively reset.

7. The electromagnetic relay assembly of claim 6 wherein the stator-guiding means comprise a C-frame arrangement, the C-frame arrangement comprising a pair of C-frame pairings, each C-frame pairing comprising an outer C-shaped frame and an inner C-shaped frame, the inner C-shaped frames being nestedly received in the outer C-shaped frames, the C-shaped frames each comprising a top C portion, a bottom C portion, and a spine C portion, the top C portions of the inner and outer C-shaped frames being received by the distal end bobbins, the bottom C portions of the inner C-shaped frames extending toward the proximal end bobbins in a common inner bottom frame plane, the bottom C portions of the outer C-shaped frames extending toward the proximal end bobbins in a common outer bottom frame plane, the inner bottom frame plane and the outer bottom frame plane being substantially parallel, the distal stator ends of the SET plates interfacing with the bottom C portions of the outer C-shaped frames when the relay assembly is operatively set and the distal stator ends of the RESET plates interfacing with the bottom C portions of the inner C-shaped frames when the relay assembly is operatively reset.

8. The electromagnetic relay assembly of claim 7 wherein the stator-guiding means comprise a pair of proximal C-shaped frames, the bottom C portions of each proximal C-shaped frame comprising a first frame surface and a second frame surface, the top C portions of the proximal C-shaped frames being received by the proximal end bobbins, the bottom C portions of the proximal C-shaped frames extending toward the distal end bobbins in a common proximal bottom frame plane, the proximal bottom frame plane, the inner bottom frame plane, and the outer bottom frame plane being substantially parallel, the proximal bottom frame plane extending intermediate the inner and outer bottom frame planes, the RESET plates interfacing with the first frame surface of the proximal C-shaped frames when the relay assembly is operatively set and the SET plates interfacing with the second frame surface of the proximal C-shaped frames when the relay assembly is operatively reset.

9. The electromagnetic relay assembly of claim 8.wherein the top C portions of the outer C-shaped frames extend toward one another in a common outer top frame plane, the top C portions of the inner C-shaped frames extend toward one another in a common inner top frame plane, and the top C portions of the proximal C-shaped frames extend away from one anther in a common proximal top frame plane, the proximal top frame plane being sandwiched intermediate the outer top frame plane and the inner top frame plane in radially inward adjacency to the coils.

10. The electromagnetic relay assembly of claim 5 comprising a select configuration, the select configuration being selected from the group consisting of a terminal-block type configuration, a dock-on type configuration, and an inside-mounted type configuration.

11. The electromagnetic relay assembly of claim 5 wherein the transformer assembly comprises a neutral terminal assembly.

12. A electromagnetic motor assembly for use in combination with a relay assembly, the electromagnetic motor assembly comprising, in combination:
a union coil assembly, the union coil assembly comprising at least two unit coil assemblies and coil-energizing means, the unit coil assemblies each comprising a coil, a distal end bobbin, a proximal end bobbin, and stator-guiding means, the proximal end bobbins being cooperatively associated for aligning the coils in end-to-end relation about a common coil axis; and
an actuator assembly, the actuator assembly comprising an actuator carriage, a pair of stator assemblies, and a plurality of drive bridge assemblies, the actuator carriage comprising stator-receiving means and bridge-receiving means, the actuator carriage receiving and spatially locating the stator assemblies and the drive bridge assemblies, each stator assembly comprising a first stator plate, a second stator plate, a drive magnet, a proximal stator end, and a distal stator end, the drive magnet being sandwiched intermediate the first and second stator plates, the actuator assembly being cooperatively assembled with the union coil assembly, the stator ends being cooperatively guidable by the stator-guiding means, the coil-energizing means being cooperatively associated with the union coil assembly for selectively directing electrical current therethrough, the electrical current for selectively driving the actuator assembly, the actuator assembly being co operable with an electromagnetic relay assembly.

13. The electromagnetic motor assembly of claim 12 being outfitted in combination with the electromagnetic relay assembly, the combination electromagnetic relay assembly comprising, in combination, the electromagnetic motor assembly, a plurality of transformer assemblies, and a housing assembly, each transformer assembly comprising an IN-contact assembly, an OUT-contact assembly, contact bridging means, and a current transformer, the IN-contact assembly comprising an IN-terminal, the OUT-assembly comprising an OUT-terminal, and a first contact point, the contact bridging means comprising second, third, and fourth contact points, and a contact spring, the housing assembly for enabling selective current-directing communication intermediate the contact points and the motor assembly, the drive bridge assemblies being cooperatively associated with the transformer assemblies for selectively setting the electromagnetic relay assembly, the second stator plates interfacing with the stator-guiding means and the drive bridges compressing the contact spring thus separating the second and third contact points from the first and fourth contact points when the relay assembly is operatively set, the first stator plates interfacing with the stator-guiding means and the drive bridges restoring the contact spring thus placing the second and third contact points into contact with the first and fourth contact points when the relay assembly is operatively reset.

14. The assembly of claim 12 wherein the stator-guiding means comprise a C-frame arrangement, the C-frame arrangement comprising a pair of C-frame pairings, each C-frame pairing comprising an outer C-shaped frame and an inner C-shaped frame, the inner C-shaped frames being nestedly received in the outer C-shaped frames, the C-shaped frames each comprising a top C portion, a bottom C portion, and a spine C portion, the top C portions of the inner and outer C-shaped frames being received by the distal end bobbins, the bottom C portions of the inner C-shaped frames extending toward the proximal end bobbins in a common inner bottom frame plane, the bottom C portions of the outer C-shaped frames extending toward the proximal end bobbins in a common outer bottom frame plane, the inner bottom frame plane and the outer bottom frame plane being substantially parallel, the distal stator ends of the second stator plates interfacing with the bottom C portions of the outer C-shaped frames when the relay assembly is operatively set and the distal stator ends of the first stator plates interfacing with the bottom C portions of the inner C-shaped frames when the relay assembly is operatively reset.

15. The assembly of claim 14 wherein the stator-guiding means comprise a pair of proximal C-shaped frames, the bottom C portions of each proximal C-shaped frame comprising a first frame surface and a second frame surface, the top C portions of the proximal C-shaped frames being received by the proximal end bobbins, the bottom C portions of the proximal C-shaped frames extending toward the distal end bobbins in a common proximal bottom frame plane, the proximal bottom frame plane, the inner bottom frame plane, and the outer bottom frame plane being substantially parallel, the proximal bottom frame plane extending intermediate the inner and outer bottom frame planes, the second stator plates interfacing with the first frame surface of the proximal C-shaped frames when the relay assembly is operatively set and the first stator plates interfacing with the second frame surface of C-shaped frames when the relay assembly is operatively reset.

16. The assembly of claim 15 wherein the top C portions of the outer C-shaped frames extend toward one another in a common outer top frame plane, the top C portions of the inner C-shaped frames extend toward one another in a common inner top frame plane, and the top C portions of the proximal C-shaped frames extend away from one anther in a common proximal top frame plane, the proximal top frame plane being sandwiched intermediate the outer top frame plane and the inner top frame plane in radially inward adjacency to the coils.

17. The assembly of claim 12 comprising a select configuration, the select configuration being selected from the group consisting of a terminal-block type configuration, a dock-on type configuration, and an inside-mounted type configuration.

18. The assembly of claim 12 wherein the union transformer assembly comprises a neutral terminal assembly.

19. An electromagnetic relay assembly, the electromagnetic relay assembly comprising, in combination:
a motor assembly, the motor assembly comprising at least one coil assembly and an actuator assembly, the coil assembly comprising at least one coil, stator-guiding means, and coil-energizing means, the actuator assembly comprising at least one stator assembly and force-transferring means, the stator assembly extending intermediate the stator-guiding means and comprising opposite stator ends, the stator assembly comprising a first and second stator plates and at least one drive magnet, the drive magnet being sandwiched intermediate the first and second stator plates, the actuator assembly being cooperatively assembled with the coil assembly, the stator ends being cooperatively guided by the stator-guiding means;
at least one transformer assembly, the transformer assembly comprising an IN-contact assembly, an OUT-contact assembly, contact-bridging means, and a transformer, the IN-contact assembly comprising first current-directing means, the OUT-assembly comprising second current-directing means and a first contact point, the contact-bridging means comprising second, third, and fourth contact points, and contact-restoring means; and
transformer-motor-communicating means, the transformer-motor-communicating means for enabling selective current-directing communication intermediate the contact points and the motor assembly, the coil-energizing means being cooperatively associated with coil assembly for selectively directing electrical current therethrough, the electrical current for creating an actuating-force, the actuating-force for actuating the actuator assembly, the force-transferring means being cooperatively associated with the transformer assembly for directing current flow through the contact points, the current flow for enabling electrical communication away from the relay assembly via the first and second current-directing means.

20. The electromagnetic relay assembly of claim 19 comprising multi-phasing means, the multi-phasing means being enabled by at least two tandemly-oriented coil assemblies, at least two stator assemblies, a plurality of drive bridge assemblies, and a plurality of transformer assemblies, the stator-guiding means being cooperatively associated with the coil assemblies for aligning the coils in end-to-end relation about a common coil axis, each stator assembly comprising a distal stator end and a proximal stator end, the distal stator ends of the second stator plates interfacing with the stator-guiding means when the relay assembly is operatively set and the distal stator ends of the first stator plates interfacing with the stator-guiding means when the relay assembly is operatively reset.

21. The electromagnetic relay assembly of claim 20 comprising a select configuration, the select configuration being selected from the group consisting of a terminal-block type configuration, a dock-on type configuration, and an inside-mounted type configuration.
